(19) United States
(12) Patent Application Publication
(10) Pub. No.: US 2024/0145109 A1
(43) Pub. Date: May 2, 2024

(54) RADIATION PROTECTION GARMENT

(71) Applicant: Jihad Ali Mustapha, Ada, MI (US)

(72) Inventor: Jihad Ali Mustapha, Ada, MI (US)

(21) Appl. No.: 18/384,344

(22) Filed: Oct. 26, 2023

Related U.S. Application Data
(60) Provisional application No. 63/419,421, filed on Oct. 26, 2022.

(51) Int. Cl. G21F 3/025; A41D 13/005; A41D 13/04; A41D 13/05; A41D 13/08; G21F 1/08

(52) U.S. Cl. CPC G21F 3/025; A41D 13/0053; A41D 13/04; A41D 13/0543; A41D 13/08; G21F 1/085; A41D 2200/10

(57) ABSTRACT

A radiation protection garment. The radiation protection garment includes one or more lead-based panels and a cooling system. The cooling system includes one or more air flow paths containing air and one or more air vents that provide fluid communication between atmosphere and the one or more air flow paths. Movement of the radiation protection garment causes the air in the one or more air flow paths to flow through the one or more air flow paths and exit through the one or more air vents. Additionally, or alternatively, the radiation protection garment includes one or more lead-based panels and a support system. The support system distributes a weight of the radiation protection garment away from at least one of a neck or a lower back of a user while the user is wearing the radiation protection garment.

### CROSS-REFERENCE TO RELATED APPLICATIONS

This application claims priority to U.S. Provisional Application No. 63/419,421, filed Oct. 26, 2022, the entire contents of which is hereby incorporated by reference.

### TECHNICAL FIELD

The present invention relates to radiation protection garments, and, more particularly, to an improved radiation protection garment.

### BACKGROUND

Radiation protection garments, such as lead aprons and/or lead skirts, are used to protect users from harmful radiation during, for example, x-ray procedures.

### BRIEF SUMMARY OF THE INVENTION

According to one embodiment, a radiation protection garment includes one or more lead-based panels and a cooling system. The cooling system includes one or more air flow paths and one or more air vents. The one or more air flow paths contain air. The one or more air vents provide fluid communication between atmosphere and the one or more air flow paths. Movement of the radiation protection garment causes the air in the one or more air flow paths to flow through the one or more air flow paths.

According to another embodiment, a radiation protection garment includes one or more lead-based panels and a support system. The support system distributes a weight of the radiation protection garment away from at least one of a neck or a lower back of a user while the user is wearing the radiation protection garment.

Additional features, advantages, and embodiments of the invention are set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1A illustrates a schematic, front view of a radiation protection garment in a closed state, according to the present disclosure.

FIG. 1B illustrates a schematic, front view of the radiation protection garment of FIG. 1A in an opened state, according to the present disclosure.

FIG. 2A illustrates a schematic, front view of the radiation protection garment of FIGS. 1A and 1B in the closed state and being worn by a user, according to the present disclosure.

FIG. 2B illustrates a schematic, rear view of the radiation protection garment of FIGS. 1A, 1B, and 2A in the closed state and being worn by the user, according to the present disclosure.

FIG. 3 is a front view of one or more radiation protection arm guards for the radiation protection garment worn by the user, according to the present disclosure.

FIG. 4A is a front view of one or more radiation protection shin guards for the radiation protection garment worn by the user, according to the present disclosure.

FIG. 4B is a rear view of the one or more radiation protection shin guards of FIG. 4A for the radiation protection garment worn by the user, according to the present disclosure.

FIG. 5 is a front view of radiation protection underwear of the radiation protection garment, according to the present disclosure.

FIG. 6A illustrates a schematic, front view of a radiation protection garment in a closed state and worn by the user, according to the present disclosure.

FIG. 6B illustrates a schematic, rear view of the radiation protection garment of FIG. 6A in the closed state and worn by the user, according to the present disclosure.

FIG. 6C illustrates a schematic, side view of the radiation protection garment of FIGS. 6A and 6B in the closed state and worn by the user with arms lowered, according to the present disclosure.

FIG. 6D illustrates a schematic, side view of the radiation protection garment of FIGS. 6A to 6C in the closed state and worn by the user with arms raised, according to the present disclosure.

FIG. 6E is an enlarged, schematic, side view of the radiation protection garment of FIGS. 6A to 6D, taken at detail 6E in FIG. 6C, according to the present disclosure.

FIG. 7A is a schematic right side view of the user wearing the radiation protection garment of FIGS. 6A to 6E while the user is standing straight up, according to the present disclosure.

FIG. 7B is a schematic rear view of the user wearing the radiation protection garment of FIGS. 6A to 6E while the user is bent over, according to the present disclosure.

FIG. 7C is a schematic left side view of the user wearing the radiation protection garment of FIGS. 6A to 6E while the user is bent over, according to the present disclosure.

FIG. 8A is a schematic side view of one or more radiation protection shin guards for the radiation protection garment worn by the user, according to the present disclosure.

FIG. 8B is a schematic side view of the one or more radiation protection shin guards for the radiation protection garment worn by the user, according to the present disclosure.

FIG. 8C is a schematic rear view of the one or more radiation protection shin guards for the radiation protection garment worn by the user, according to the present disclosure.

FIG. 9 is a schematic front view of radiation protection underwear for the radiation protection garment, according to the present disclosure.

FIG. 10A illustrates a schematic front view of a radiation protection undergarment for the radiation protection garment, according to the present disclosure.

FIG. 10B illustrates a schematic front side view of the radiation protection undergarment of FIG. 10A for the radiation protection garment, according to the present disclosure.

### DETAILED DESCRIPTION OF THE INVENTION

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

The terms “top”, “bottom,” “front side,” “rear side,” “right side,” and “left side” refer to relative positions of the radiation protection garment based on the orientation shown in the figures, respectively, unless stated otherwise.

As used herein, the terms “first,” “second,” “third,” “fourth,” “fifth,” “sixth,” etc. may be used interchangeably to distinguish one component from another and are not intended to signify location or importance of the individual components.

As used herein, the terms “cool” and “warm” or their respective comparative degrees (e.g., “cooler” and “warmer,” where applicable), refers to relative temperatures within the radiation protection garment and outside of the radiation protection garment unless otherwise specified. For example, “cool air” has a lower temperature than “warm air.” In the exemplary embodiment, “cool air” is a lower temperature than a body temperature of a user and “warm air” is air that has been warmed by the body temperature of the user.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, a two, a four, a ten, a fifteen, or a twenty percent margin in either individual values, range(s) of values and/or endpoints defining range(s) of values.

Radiation protection garments are used to protect users from harmful radiation during, for example, x-ray procedures. Lead aprons and/or lead skirts are one example of radiation protection garments that are used to protect users from harmful radiation during, for example, x-ray procedures. Current radiation protection garments are heavy, and the weight of the radiation protection garment applies pressure on the user such that the user's neck and back are strained while wearing the radiation protection garment. Further, current radiation protection garments cause the user to heat up and perspire while wearing the radiation protection garment. Current radiation protection garments also require the user to be measured and need to be adjusted to fit the user's size. Moreover, many current radiation protection garments have arm portions that curve inwards so that the user can move their arms while wearing the radiation protection garment. Such a configuration, however, exposes tissue, including, mammillary tissue (e.g., breasts) of the user to the harmful radiation.

The present disclosure provides for an improved radiation protection garment, while complying with regulations that require a thickness of the lead-based panels in the radiation protection garment to be at least zero point five millimeters (0.5 mm) as defined by both federal government and state government regarding such radiation protection garments for protection against radiation. The radiation protection garment can include a lead apron and/or a lead skirt. The radiation protection garment includes a system and/or configuration that allows for aeration, breathability and/or cooling. In one aspect, the radiation protection garment includes a cooling system with one or more air flow paths, also referred to as air tunnels, within the radiation protection garment. While cooling system is described herein as containing air tunnels and circulating air, the cooling system can include any type of gas, liquid, or solid for cooling the user while wearing the radiation protection garment. Further, the air in the cooling system is ambient air that is a lower temperature than body heat from the user. The ambient air circulates through the cooling system to cool the user, as detailed further below.

The cooling system helps to cool the user while the user is wearing the radiation protection garment to reduce or to prevent the user from perspiring. The air tunnels can be located in a front side, a back side, and/or the sides of the radiation protection garment. The cooling system can be located in the apron and/or the skirt. The air tunnels of the cooling system allow for any possible condensation (e.g., due to excessive sweating of the user) to evaporate through the air tunnels. While the user moves, motion of the user's body generates energy that propels the air to move in all directions within the air tunnels. As air passes over the condensation, a cooler system of air forms (e.g., cooler air) and that cooler system (e.g., the cooler air) is then mixed with air that is in stasis (e.g., air that is stationary and not in motion) within the radiation protection garment. The air that is in stasis is warm air and is warmer than the cooler air that is in motion. Therefore, when the cooler air in motion comes in contact with the warmer air in stasis, the cooler air mixes with the warmer air, thereby creating a summation of the cool air and the warm air. The overall temperature within the radiation protection garment is lowered due to the amount of cooler air in motion within the air tunnels being greater than the amount of warm air in stasis. In this way, the cooling system helps to reduce condensation within the radiation protection garment and helps to cool the radiation protection garment.

The cooling system includes one or more vents (e.g., air vents) on the radiation protection garment to provide fluid communication from ambient air to the air tunnels. The locations of the vents are positioned in areas where the user's body motions act as the source of energy required to move the air so the operator or the person wearing the apron (e.g., the user) does not have to do any additional work to cause the air to move within the air tunnels. The air tunnels are positioned to operate independently of direct command such that the air tunnels are directly proportional to the user's body movements. In this way, the user's body movements causes the air to circulate through the air tunnels as detailed above. The user's body movements for causing the air to circulate through the air tunnels can include, for example, motion due to the user breathing and/or due to rotation of the user's torso, legs, arms, neck, back, abdomen, etc. The skirt also has air ducts channels similar to the apron and has the same mechanism of action.

The skirt of the radiation protection garment also includes an expandable belt so that the radiation protection garment can fit on users of various sizes (e.g., one-size-fits all). The expandable belt includes a lead material and an elastic material that are looped together in an accordion-like formation. Therefore, the user's waist is accommodated from a broad spectrum of sizes due to the accordion-like formation of the lead material and the elastic material. If the expandable belt is completely expanded, the lead material will expand from the accordion-like formation to a flat formation (e.g., an expanded formation), while maintaining radiation protection. Accordingly, the expandable belt can accommodate many body sizes without the need to measure a user's waist. The combined lead material and elastic material together can be narrow at the waist and wide at the bottom above the knee to allow for a confirmation and configuration accommodation while maintaining radiation protection. The expandable belt provides variable waist accommodation so a broad spectrum of sizes can be accommodated by a single radiation protection garment. In this way, the expandable belt reduces or eliminates the need for each user to be measured to fit the radiation protection garment on the user. Accordingly, the expandable belt eliminates significant expense as well as significantly reduces the amount of time for physicians or other healthcare providers by removing the need to measure each user. For example, the radiation protection garment of the present disclosure eliminates the need for physicians to wait for the user to be measured and eliminates the need for the radiation protection garment to be built and tested. The expandable belt accommodates the user's body and can be automatically adjusted to the user's body (e.g., expanded and retracted to fit the user's body) without the extra steps of measuring the user and fitting or building the radiation protection garment to fit the user. The physician or healthcare provider only needs to attach the fastener (e.g., Velcro®) on the front end of the radiation protection garment and adjust the expandable belt to fit the user.

Accordingly, the accordion-like formation of the expandable belt allows a wide range of body sizes to be able to wear a single radiation protection garment without the need to make any further adjustments. For example, the radiation protection garment of the present disclosure can accommodate all sizes without having to measure the user's body. In this way, the radiation protection garment can accommodate all body sizes (e.g., small, medium, and large) and radiation dose sizes with the unique addition of the elastic material and lead material in the accordion-like formation that allows immediate acquisition of the radiation protection garment and muscular and one can wear and set up a rate with it on without difficulties.

The radiation protection garment also includes an intra-apron structural support system for distributing the weight of the radiation protection garment to reduce pressure on the user's neck, shoulders, and lower back. The structural support system includes an intrusion in the formation of a slight curvature toward the lumbar sacral portion of the user's body (e.g., the lower back) with additional support at the level of the bilateral iliac crest bones (e.g., the hips). The combination of the intrusion and the additional support at the bilateral iliac crest together create a foundation of the support system to the person wearing the radiation protection garment. Current support systems typically rest over the user's shoulders, thereby causing strain on the shoulders, neck, and lower back. The support system of the present disclosure is disposed over the user's back and does not extend over the shoulders. In particular, the support system of the present disclosure rests on the user's hip bones rather than the shoulders. The support system of the present disclosure is less bulky than current support systems, and, therefore, weighs less than current support systems.

The support system includes an angulated belt (e.g., the expandable belt) that also reduces the pressure in the lumbar and sacral region and distributes the pressure across the lateral aspect of the user's back and toward the iliac crests by providing additional support about the waist area. The expandable belt and the support system can also be extended in various directions to redirect the distribution of weight away from the most problematic anatomical portion of the user's back. Accordingly, for a user that has a cervical anatomical medical condition, the expandable belt and a support system of the iliac crest will alleviate any pressure onto the cervical spine and distribute all the weight of the entire radiation protection garment toward the iliac crest abdomen and partially on to the lower back (e.g., in particular on to the hips). If a user has anatomical health issues in the lumbar sacral region, the support system can distribute the weight of the radiation protection garment to areas away from the lower back and more toward the iliac crest and as well as the lateral aspect of the axillary region (e.g., the midaxillary line that divides the body into the anterior side and the posterior side) and toward the abdominal wall. As discussed above, the distribution of the weight is automatically achieved by the intra-apron support system that is placed on angulations that pulls away from the vertebrae. Therefore, the expandable belt and the support system that are located in the central portion of the vertebrae at the level of the lumbar and sacral region help to redirect the weight away from the center of the vertebrae toward the lateral aspect of the torso. Further, superior secondary bouts are directed away from the cervical vertebrae (e.g., the neck) toward the shoulders via a secondary support mechanism at the midaxillary line to accommodate the weight of the radiation protection garment and remove substantially all of the pressure from the cervical spine (e.g., the neck) and the shoulders.

Accordingly, the support system of the radiation protection garment is able to accommodate the length of the vertebrae from the cervical spine to the lumbar sacral region. Therefore, the improved radiation protection garment includes a reduced weight and the support system and the cooling system that are embedded within the radiation protection garment function together independently of the user's input. Accordingly, the radiation protection garment of the present disclosure alleviate common problematic rheumatic (e.g., relating to the joints, tendons, ligament, muscles, bones, etc.) diseases caused by current radiation protection garments that do not include the benefit of the present disclosure.

The radiation protection garment can also accommodate any exoskeleton, endoskeleton, and intra skeleton to support any type of support system. To provide a healthy support system for the operators and healthcare providers, the systems embedded in the radiation protection garment are functionally compatible with various types of exoskeleton systems or endoskeletons. The radiation protection garment of the present disclosure provides for enhanced safety of the users and healthcare providers, including radiation protection, muscular skeletal protection, and increased timeframe in which a healthcare provider can operate without having to compromise the health of the users or healthcare providers.

Current radiation protection garments include lead at the chest area that is curved inwards at a clavicle of the user. As mentioned above, such a configuration doesn't cover an entire breast of the user. For example, mammillary tissue of the user can be exposed with current radiation protection garments due to the curved portion of the lead. Such an issue particularly occurs in females and males with additional fat in the breasts. When females wear bras, especially sports bras, the bra lifts the breast such that the breast extends outward of the clavicle (e.g., outward beyond the midaxillary line of the user) so a portion of the breast is exposed to the radiation. The current radiation protection garments may not entirely cover and protect the breasts of the user, thereby leaving the breasts exposed to the harmful radiation. The radiation protection garment of the present disclosure, however, includes lead in the apron that extends outward to cover the mammillary tissue.

The radiation protection garment of the present disclosure can also include additional radiation protection to protect the bone marrow and skin at the level of the anterior shin, as well as the forearms, the neck, face and brain. For example, the radiation protection garment also includes one or more arm guards that protects the forearm and covers the user's hands and knuckles. The radiation protection garment also includes one or more shin guards that protects the user's legs (e.g., the shins). The one or more shin guards are placed on a mid-calf area of the user to protect against hair loss. Current shin guards include a hook and loop fastener (e.g., Velcro®) to secure the shin guards on the user's legs and the shin guards tend to fall down when the user moves or walks around. The one or more shin guards of the present disclosure include an extended portion at a bottom of the one or more shin guards. The extended portion extends over the user's foot and provides a rest for the one or more shin guards to prevent the one or more shin guards from sliding down the user's legs. The hook and loop fastener of current shin guards loosens with contraction of the user's calf. The one or more shin guards of the present disclosure also include zippers for securing the one or more shin guards about the user's legs. The zippers help to keep the one or more shin guards secure about the user's legs.

Scatter radiation is unpredictable and known to be able to reach the genitals of both male and female by bouncing off the patient or other objects that changed to the reaction of the scatter radiation. Scatter radiation is radiation that spreads out in different directions from a radiation beam (e.g., an x-ray) when the radiation beam interacts with a substance (e.g., body tissue, the ground, a table, etc.). The radiation protection apron includes an outwardly curved collar portion that extends forward from the radiation protection apron. Such a configuration allows the outwardly curved collar portion to reflect the scatter radiation and to protect the neck and head of the user from the radiation. Further, an additional undergarment bra and underwear are provided to protect the male and female genitalia as well as the breast tissue in the axillary tissue. The undergarment bra and underwear also protect the user from direct radiation and scatter radiation. The undergarment bra and underwear are within the standard of care requirements of the federal regulations and state regulations for radiation protection. The underwear help to protect the user's genitals from scatter radiation, including, scatter radiation that reflects off of the floor. The underwear includes triangle-shaped lead.

The radiation protection garment of the present disclosure also includes a reduced weight as compared to radiation protection garments without the benefit of the present disclosure. For example, the amount of lead in the radiation protection garment is reduced, while still maintaining the amount of lead required to comply with both the federal regulations and state regulations (e.g., having a required 0.5 mm of thickness on a front side of the radiation protection garment). The lead in the radiation protection garment is thinned down and includes a greater amount of lead in the front side as compared to the back side of the radiation protection garment. In this way, the radiation protection garment includes a lesser amount of lead as compared to radiation protection garments without the benefit of the present disclosure. For example, the radiation protection garment is at least five pounds less than similarly sized current radiation protection garments. Accordingly, the radiation protection garment of the present disclosure is lighter than current radiation protection garments and still provides adequate radiation protection with the required amount of lead. In this way, the reduced weight helps to alleviate or otherwise reduce the pressure on the user as compared to radiation protection garments without the benefit of the present disclosure, thereby reducing discomfort or risk of injury.

Accordingly, the present disclosure provides for an improved radiation protection garment with a reduced weight, a support system that reduces the pressure on the user's neck and lower back, a cooling system that cools the user while wearing the radiation protection garment, and an expandable belt that allows the radiation protection garment to fit various body sizes.

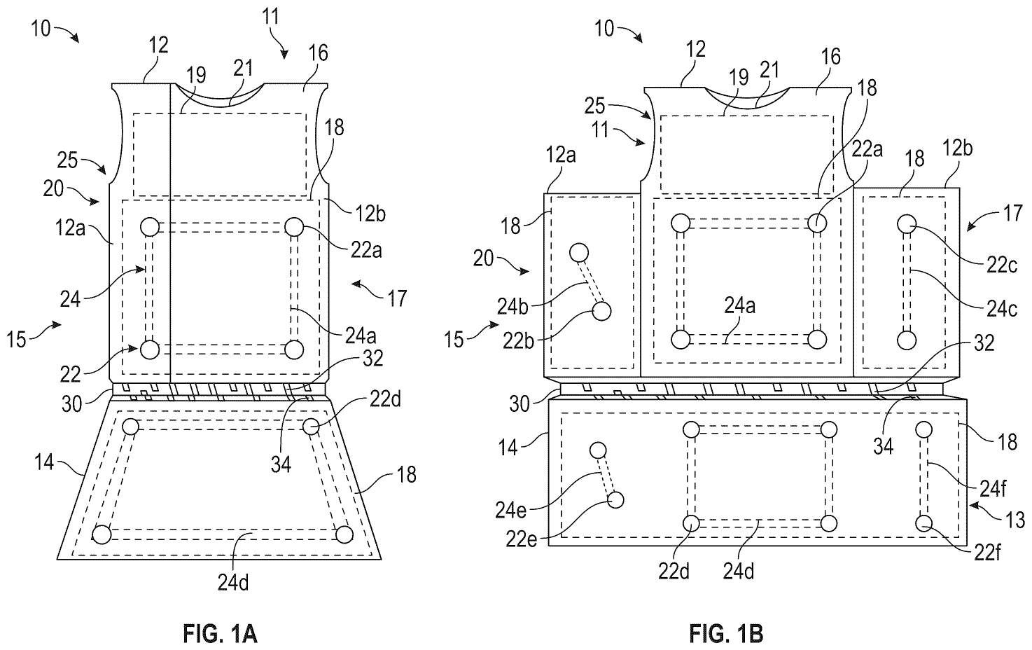

Referring now to the drawings, FIG. 1A illustrates a schematic, front view of a radiation protection garment 10 in a closed state, according to the present disclosure. FIG. 1B illustrates a schematic, front view of the radiation protection garment 10 in an opened state, according to the present disclosure. As used herein, the “closed state” and the “opened state,” and variations thereof, are reference states as shown in FIGS. 1A and 1B, respectively, and the radiation protection garment 10 of the present disclosure is not limited to the closed state and the opened state shown in FIGS. 1A and 1B. The closed state and the opened state can include different states than as shown in FIGS. 1A and 1B, respectively. The radiation protection garment 10 can also include various states other than a closed state and an opened state, including, for example, a partially closed state, a partially opened state, or any state between a closed state and an opened state.

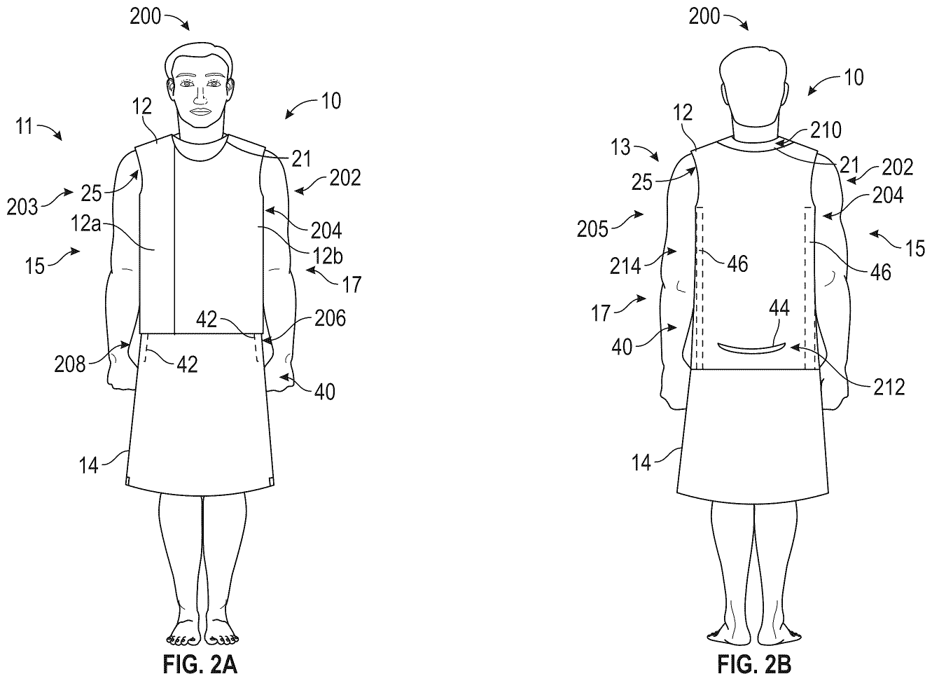

The radiation protection garment 10 includes at least one of a radiation protection apron 12 and a radiation protection skirt 14. For example, the radiation protection garment 10 can include the radiation protection apron 12, the radiation protection skirt 14, or both the radiation protection apron 12, the radiation protection skirt 14. The radiation protection apron 12 and the radiation protection skirt 14 can be separate components or can be formed together as a single unitary component that forms the radiation protection garment 10. The radiation protection garment 10 includes a front side 11 (FIG. 1A), a rear side 13 (FIG. 2B), a left side 15, and a right side 17. The radiation protection apron 12 includes a first apron flap 12a and a second apron flap 12b. When in the closed state (FIG. 1A), the first apron flap 12a and the second apron flap 12b overlap each other to close and secure the radiation protection apron 12 on the user. In FIG. 1A, the second apron flap 12b overlaps the first apron flap 12a. In some embodiments, the first apron flap 12a can overlap the second apron flap 12b.

The radiation protection garment 10 includes an outer layer 16 that contains one or more lead-based panels 18 (shown schematically by dashed lines in FIGS. 1A and 1B) therein for protection against radiation. The lead-based panels 18 are surrounded by the outer layer 16. The lead-based panels 18 can be disposed within, or partially within, the outer layer 16. In some embodiments, the lead-based panels 18 can form a part of the outer layer 16. In some embodiments, the lead-based panels 18 can be disposed outside of the outer layer 16. The outer layer 16 is made, for example, from high-strength fiber, such as nylon or the like, to form the radiation protection garment 10. The lead-based panels 18 of the radiation protection garment 10 protect a user from harmful x-ray radiation. For example, the lead-based panels 18 protect the user's chest, abdomen, back, thighs and groin area.

The first apron flap 12a includes one or more of the one or more lead-based panels 18. The second apron flap 12b includes one or more of the one or more lead-based panels 18. In this way, when the first apron flap 12a and the second apron flap 12b overlap, the one or more of the one or more lead-based panels 18 in the first apron flap 12a overlap with the one or more of the one or more lead-based panels 18 in the second apron flap 12b. Thus, the one or more of the lead-based panels 18 in the first apron flap 12a and in the second apron flap 12b include a reduced thickness as compared to radiation protection aprons without the benefit of the present disclosure. For example, the thickness of the one or more lead-based panels 18 in the first apron flap 12a and in the second apron flap 12b are each zero point two five millimeters (0.25 mm). In this way, when the first apron flap 12a and the second apron flap 12b overlap, the a total thickness of the one or more lead-based panels 18 in the radiation protection apron 12 is double the thickness of the one or more lead-based panels 18 in each individual apron flap 12a, 12b. For example, when each of the one or more lead-based panels 18 is 0.25 mm, the total thickness is zero point five mm (0.5 mm) when the first apron flap 12a and the second apron flap 12b overlap. Accordingly, the radiation protection garment 10 provides for a reduced amount of lead as compared to radiation protection garments without the benefit of the present disclosure, while still complying the regulations that require a thickness of 0.5 mm.

The lead-based panels 18 include one or more chest lead-based panels 19 disposed in an upper chest area of the user. The one or more chest lead-based panels 19 in the upper chest area extend laterally outward to cover an entirety of the user's breasts. For example, the one or more chest lead-based panels 19 in the upper chest area extend along an entire length of the user's clavicle. In this way, the one or more chest lead-based panels 19 cover the breasts even when the user moves, thereby protecting the breasts from the harmful radiation. In this way, the breasts do not become exposed as the breasts do with current radiation protection garments without the benefit of the present disclosure. While the one or more chest lead-based panels 19 are depicted as a separate component than the one or more lead-based panels 18, the one or more chest lead-based panels 19 can form a single, unitary component with the one or more lead-based panels 18. In some embodiments, the lead-based panels 18 can be disposed on the rear side 13 for additional radiation protection on the rear side 13. For example, the lead-based panels 18 can be positioned on the rear side 13 at the cervical neck 210 of the user 200 (FIG. 2B).

The radiation protection apron 12 also includes an outwardly curved collar portion 21 that includes one or more of the one or more lead-based panels 18. The outwardly curved collar portion 21 is positioned in a collar area of the radiation protection apron 12 and extends generally outward away from a neck of the user. For example, the outwardly curved collar portion 21 extends at an angle greater than zero degrees (0°) and less than or equal to ninety degrees (90°). In this way, the outwardly curved collar portion 21 provides a shield that reflects scatter radiation away from the neck and head of the user. For example, the outwardly curved collar portion 21 forms a curved rim that extends outward from the collar at an angle greater than 0° and less than or equal to 90° from a plane defined by the front side 11. The outwardly curved collar portion 21 can be generally frusto-conical and/or can include a curvature. In this way, the outwardly curved collar portion 21 is a partially rigid flap that shields the neck and head of the user. The outwardly curved collar portion 21 can extend circumferentially about an entirety of a collar of the radiation protection apron 12 to protect an entire circumference of the neck and the head of the user.

The radiation protection garment includes a system and/or configuration that allows for aeration, breathability and/or cooling. In one aspect, the radiation protection garment 10 includes a cooling system 20 for cooling a user while the user is wearing the radiation protection garment 10. The cooling system 20 includes one or more vents, also referred to as one or more air vents 22, and one or more flow paths, also referred to as one or more air flow paths 24. The air flow paths 24 are located inside the radiation protection garment 10. For example, the air flow paths 24 are located within the outer layer 16. In some embodiments, the one or more air flow paths 24 can be partially located or fully located outside of the outer layer 16. The air vents 22 are openings in the radiation protection garment 10 and extend through the outer layer 16 and provide fluid communication from the atmosphere (e.g., ambient) to the air flow paths 24. In some embodiments, one or more of the air vents 22 are disposed in the one or more lead-based panels 18.

The air vents 22 direct the flow (e.g., the air flow) from ambient into and out of the one or more air flow paths 24. In some embodiments, the air vents 22 can include valves. In this way, air (e.g., ambient air) can flow into and out of the air flow paths 24 through the air vents 22, as detailed further below. The air can flow in either direction within the air flow paths 24. While the air vents 22 are shown as generally circular openings, the air vents 22 can include any size and any shape for providing fluid communication from ambient to the air flow paths 24. For example, the air vents 22 can include holes, apertures, pin holes, slits, or the like. In a preferred embodiment, the air vents 22 include a diameter that is greater in diameter than a spacing of the material of the outer layer 16. In this way, the air vents 22 can be micro-holes, or very small holes (e.g., approximately the size of a pinhole), in at least one of the outer layer 16 or the one or more lead-based panels 18. Thus, in one non-limiting example, the air vents 22 have a diameter that is less than five millimeters (5 mm). The air vents 22 can include any size or any shape for allowing flow of air through the radiation protection garment 10, while minimizing an amount of radiation that can pass through a respective air vent 22.

While the cooling system 20 is described herein as containing air flow paths 24 and circulating ambient air, the cooling system 20 can include any type of gas, liquid, or solid for cooling the user while wearing the radiation protection garment 10. For example, the cooling system 20 can include a water-cooled cooling system such that the flow paths are filled with water or another liquid. Further, the air in the cooling system 20 is ambient air that is a lower temperature than body heat from the user. The ambient air circulates through the cooling system 20 to cool the user.

The air flow paths 24 include any type of path, channel, or tunnel that extend through the radiation protection garment 10 such that air can flow through the air flow paths 24 within the radiation protection garment 10. For example, the air flow paths 24 can include space between layers of the radiation protection garment 10 and/or can include discrete channels or tunnels. Thus, the air flow paths 24 include any pathway that provides fluid communication to the air vents 22. While the air flow paths 24 are depicted as generally straight paths in FIGS. 1A and 1B, the air flow paths 24 can include any size and/or any shape, as desired. Further, while the air vents 22 and the air flow paths 24 are shown on the front side 11, the left side 15, and the right side 17 of the radiation protection garment 10 in FIGS. 1A and 1B, the air vents 22 and the air flow paths 24 can be located on any side of the radiation protection garment 10. For example, the radiation protection garment 10 can include air vents 22 and air flow paths 24 on the front side, the left or right sides, and/or the rear side of the radiation protection garment 10.

The radiation protection apron 12 includes a first set of air vents 22a that are in fluid communication with a first set of air flow paths 24a, a second set of air vents 22b that are in fluid communication with a second set of air flow paths 24b, and a third set of air vents 22c that are in fluid communication with a third set of air flow paths 24c. The first set of air vents 22a and the first set of air flow paths 24a are located on the front side 11 of the radiation protection apron 12, the second set of air vents 22b and the second set of air flow paths 24b are on the left side 15 of the radiation protection apron 12 in the opened state (FIG. 1B), and the third set of air vents 22c and the third set of air flow paths 24c are on the right side 17 of the radiation protection apron 12 in the opened state (FIG. 1B).

The one or more air vents 22 are unaligned on the radiation protection apron 12 such that the one or more air vents 22 do not overlap with each other when the radiation protection apron 12 is in the closed state. For example, the second set of air vents 22b and the second set of air flow paths 24b are positioned on the first apron flap 12a. The third set of air vents 22c and the third set of air flow paths 24c are positioned on the second apron flap 12b. As shown in FIG. 1B, the second set of air vents 22b are unaligned with the third set of air vents 22c. For example, when the radiation protection apron 12 is in the closed state (e.g., the first apron flap 12a and the second apron flap 12b overlap), the second set of air vents 22b, and the third set of air vents 22c are unaligned such that the second set of air vents 22b do not overlap with the third set of air vents 22c. If the air vents 22 were aligned when the radiation protection apron 12 is in the closed state, the radiation could travel through aligned air vents 22 and contact the user. Accordingly, the unalignment of the air vents 22 on the radiation protection apron 12 allows the cooling system 20 to move air through the air vents 22 to cool the user, and the radiation is prevented from traveling through corresponding air vents 22. For example, if the radiation travels through the second set of air vents 22b, the radiation will contact the one or more lead-based panels 18 in the first apron flap 12a (rather than travelling through air vents 22 that are aligned with the second set of air vents 22b) and the one or more lead-based panels 18 will prevent the radiation from contacting the user.

FIG. 1B shows that the first set of air vents 22a includes four air vents 22, the second set of air vents 22b includes two air vents 22, and the third set of air vents 22c includes two air vents 22. FIG. 1B also shows that the first set of air flow paths 24a includes four air flow paths 24 in a generally rectangular configuration, the second set of air flow paths 24b includes one air flow path 24 in a generally straight-line configuration, and the third set of air flow paths 24c includes one air flow path 24 in a generally straight-line configuration. The first set of air vents 22a, the second set of air vents 22b, and the third set of air vents 22c, and the first set of air flow paths 24a, the second set of air flow paths 24b, and the third set of air flow paths 24c can include any number of air vents 22 and air flow paths 24 located in any position, respectively, and can be configured in any configuration or shape, as desired.

The radiation protection skirt 14 includes a fourth set of air vents 22d that are in fluid communication with a fourth set of air flow paths 24d, a fifth set of air vents 22e that are in fluid communication with a fifth set of air flow paths 24e, and a sixth set of air vents 22f that are in fluid communication with a sixth set of air flow paths 24f. The fourth set of air vents 22d and the fourth set of air flow paths 24d are located on the front side 11 of the radiation protection skirt 14, the fifth set of air vents 22e and the fifth set of air flow paths 24e are on the left side 15 of the radiation protection skirt 14 in the opened state (FIG. 1B), and the sixth set of air vents 22f and the sixth set of air flow paths 24f are on the right side 17 of the radiation protection skirt 14 in the opened state (FIG. 1B). When the radiation protection skirt 14 is in the closed state (FIG. 1A), the fifth set of air vents 22e and the fifth set of air flow paths 24e, and the sixth set of air vents 22f and the sixth set of air flow paths 24f, are on the rear side 13 of the radiation protection skirt 14. For example, when the radiation protection skirt 14 is worn by a user and secured on the user, the left side 15 and the right side 17 of the radiation protection skirt 14 wrap around the user and are secured on the rear side 13 such that the fifth set of air vents 22e and the fifth set of air flow paths 24e, and the sixth set of air vents 22f and the sixth set of air flow paths 24f, are on the rear side 13. FIG. 1B shows that the fourth set of air vents 22d includes four air vents 22, the fifth set of air vents 22e includes two air vents 22, and the sixth set of air vents 22f includes two air vents 22. The fourth set of air vents 22d, the fifth set of air vents 22e and the sixth set of air vents 22f are unaligned such that the fourth set of air vents 22d, the fifth set of air vents 22e and the sixth set of air vents 22f do not overlap each other when the radiation protection skirt 14 is in the closed state, as detailed above. FIG. 1B also shows that the fourth set of air flow paths 24d includes four air flow paths 24 in a generally rectangular configuration, the fifth set of air flow paths 24e includes one air flow path 24 in a generally straight-line configuration, and the sixth set of air flow paths 24f includes one air flow path 24 in a generally straight-line configuration. The fourth set of air vents 22d, the fifth set of air vents 22e, and the sixth set of air vents 22f, and the fourth set of air flow paths 24d, the fifth set of air flow paths 24e, and the sixth set of air flow paths 24f can include any number of air vents 22 and air flow paths 24 located in any position, respectively, and can be configured in any configuration, as desired.

The radiation protection apron 12 includes a convex sleeve portion 25 that extends generally laterally from the front side 11. The convex sleeve portion 25 provides additional material such that the one or more chest lead-based panels 19 can extend across an entirety of the breasts of the user. In this way, the radiation protection apron 12 protects the breasts from being exposed when worn by the user as compared to radiation protection aprons without the benefit of the present disclosure.

The radiation protection garment 10 also includes an expandable belt 30. The expandable belt 30 expands and retracts such that the radiation protection garment 10 fits users of various sizes. The expandable belt 30 can be a separate component from the radiation protection apron 12 and the radiation protection skirt 14 or can be formed with the radiation protection apron 12 and/or the radiation protection skirt 14 such that the radiation protection garment 10 and the expandable belt 30 form a single unitary component. The expandable belt 30 includes one or more lead strips 32 and one or more elastic elements 34. The one or more lead strips 32 and the one or more elastic elements 34 are looped or are otherwise coupled together in an accordion-like formation to form the expandable belt 30. In this way, the expandable belt 30 can be stretched to fit users of various sizes. The one or more lead strips 32 allow the expandable belt 30 to stretch or expand while also protecting the user from harmful radiation. For example, the one or more lead strips 32 protect against the radiation even if the expandable belt 30 is stretched. Accordingly, the expandable belt 30 allows the radiation protection skirt 14 to be a one-size-fits-all configuration such that the radiation protection skirt 14 can fit a person of any size.

FIG. 2A illustrates a schematic, front view of the radiation protection garment 10 in the closed state and being worn by a user 200, according to the present disclosure. FIG. 2B illustrates a schematic, rear view of the radiation protection garment 10 in the closed state and being worn by the user 200, according to the present disclosure. The lead panels, the air vents, and the air flow paths are not illustrated in FIGS. 2A and 2B for clarity. The user 200 has a body 202 with a torso 204. FIG. 2A shows an anterior side 203 (e.g., front side) of the body 202 and FIG. 2B shows a posterior side 205 (e.g., back side) of the body 202. The body 202 includes a pelvis 206 (FIG. 2A) having a bilateral iliac crest 208 (FIG. 2A). The bilateral iliac crest 208 includes arching bones of the pelvis 206 that look like wings and extend to the user's hips and lower back. As shown in FIG. 2B, the body 202 also includes a cervical spine 210, a lumbosacral region 212, and a midaxillary line 214. The cervical spine 210 is the neck region of the user 200 and consists of the C1-C7 vertebrae. The lumbosacral region 212 includes the lumbar region and the sacrum of the user 200. The lumbosacral region 212 connects the user's spine to the pelvis 206. The midaxillary line 214 is an imaginary line that extends through the user's torso 204 and separates the body 202 into the anterior side 203 and the posterior side 205. Current radiation protection garments apply a pressure on the body 202 while the user 200 is wearing the radiation protection garment. In this way, current radiation protection garments may strain the cervical spine 210 and/or the lumbosacral region 212, thereby causing discomfort, injury, and/or exacerbating existing injuries. Therefore, the radiation protection garment 10 of the present disclosure provides for a support system 40 as shown in FIGS. 2A and 2B.

The support system 40 supports the weight of the radiation protection garment 10 and reduces the pressure from the cervical spine 210 and/or the lumbosacral region 212 of the user 200 as compared to radiation protection garments without the benefit of the present disclosure. The support system 40 includes one or more support mechanisms that are rigid support structures, such as, for example, rods, plates, or the like. The one or more support mechanisms can be made from a lightweight metal, ceramic, or the like. The support system 40 includes a first support mechanism 42 (FIG. 2A), a second support mechanism 44 (FIG. 2B), and a third support mechanism 46 (FIG. 2B).

As shown in FIG. 2A, the first support mechanism 42 is located within the radiation protection skirt 14 and is an area of the bilateral iliac crest 208 when the radiation protection skirt 14 is worn by the user 200. The first support mechanism 42 helps to alleviate pressure on the bilateral iliac crest 208 of the user 200 to help redirect the distribution of the weight of the radiation protection garment 10 away from the user's back (e.g., the cervical spine 210 and/or the lumbosacral region 212). As shown in FIG. 2B, the second support mechanism 44 includes an indentation on the rear side 13 of the radiation protection apron 12 to provide support on the lumbosacral region 212. The indentation has a slight curvature such that the radiation protection apron 12 conforms to the curvature of the lumbosacral region 212, thereby alleviating pressure on the lumbosacral region 212. The third support mechanism 46 is located on the left side 15 and the right side 17 of the radiation protection apron 12 along the midaxillary line 214 when the radiation protection apron 12 is worn by the user 200. The third support mechanism 46 extends longitudinally along the midaxillary line 214 and accommodates the weight of the radiation protection apron 12 and removes pressure from the cervical spine 210.

The support system 40 and the expandable belt 30 (FIGS. 1A and 1B) help to distribute the weight of the radiation protection garment 10 when worn by the user 200 so the pressure is distributed away from the lumbosacral region 212. For example, the support system 40 and the expandable belt 30 distribute the pressure laterally across the user's back and toward the bilateral iliac crest 208. Accordingly, the support system 40 and the expandable belt 30 help to alleviate the pressure away from the cervical spine 210 and distribute the weight of the radiation protection garment 10 toward the bilateral iliac crest 208 and/or the lumbosacral region 212. In this way, the support system 40 and the expandable belt 30 help to alleviate discomfort, injury, and/or existing injuries (e.g., cervical anatomical medical conditions). The support system 40 and the expandable belt 30 can also be configured to distribute the pressure to areas away from the lumbosacral region 212 and toward the bilateral iliac crest 208 and/or the midaxillary line 214 and toward the abdominal wall of the user 200. In this way, the weight is distributed away from the vertebrae and is directed laterally outward on the torso 204 and redirected toward the user's shoulders. The third support mechanism 46 accommodates the weight on the midaxillary line 214. Accordingly, the support system 40 and the expandable belt 30 help to substantially reduce or remove the pressure from the cervical spine 210 as compared to radiation protection garments without the benefit of the present disclosure.

With reference to FIGS. 1A-1B and 2A-2B, in operation, the user 200 wears the radiation protection garment 10 as shown in FIGS. 2A-2B. The expandable belt 30 is adjusted to fit the around the user's waist and placed around the user's waist. The expandable belt 30 is then secured to secure the radiation protection garment 10 on the user 200. The support system 40 and the expandable belt 30 help to distribute the weight of the radiation protection garment 10, as detailed above.

The radiation protection garment 10 may cause the user 200 to perspire and sweat while the user 200 is wearing the radiation protection garment 10. The cooling system 20 helps to cool the user 200 while the user 200 is wearing the radiation protection garment 10. For example, a temperature of a portion of the air in the air flow paths 24 may increase in certain areas of the radiation protection garment 10 as the user 200 is wearing the radiation protection garment 10. In this way, the air flow paths 24 contain cool air and warm air while the user 200 wears the radiation protection garment 10. Condensation may form in the air flow paths 24 in the areas in which the warm air is located, due to, for example, the user 200 perspiring. The cool air is in areas in which the temperature of the air does not increase while the user 200 is wearing the radiation protection garment 10.

The user 200 may move, thereby causing the radiation protection garment 10 to move or otherwise adjust on the user 200. In some examples, the radiation protection garment 10 may be adjusted or moved without the user 200 having to move (e.g., a doctor or a nurse may adjust the radiation protection garment 10). The movement of the radiation protection garment 10 causes cool air in the air flow paths 24 to flow through the air flow paths 24. For example, movement of the radiation protection garment 10 causes the cool air in the air flow paths 24 to flow and to mix with the warm air, thereby cooling the warm air and reducing the overall temperature of the radiation protection garment 10 and of the user 200 while the user 200 is wearing the radiation protection garment 10. The movement of the radiation protection garment 10 causes the mixed cool air and warm air to flow and exit the one or more air vents 22. At the same time, ambient air can flow into the air flow paths 24 through the one or more air vents 22, thereby reducing the overall temperature of the radiation protection garment 10 and cooling the user 200.

Accordingly, the radiation protection apron 12, the radiation protection skirt 14, and the expandable belt 30 protect the user 200 from harmful radiation, while cooling the user (e.g., with the cooling system 20) and reducing strain on the user's back and shoulders by the support system 40. The radiation protection skirt 14 extends generally to a midriff region of the user 200 such that the radiation protection skirt 14 protects a uterus of the user 200 when the user 200 is a female. The radiation protection apron 12 can also extend to the waist of the user 200 such that both the radiation protection apron 12 and the radiation protection skirt 14 cover the midriff region to provide additional protection from the radiation.

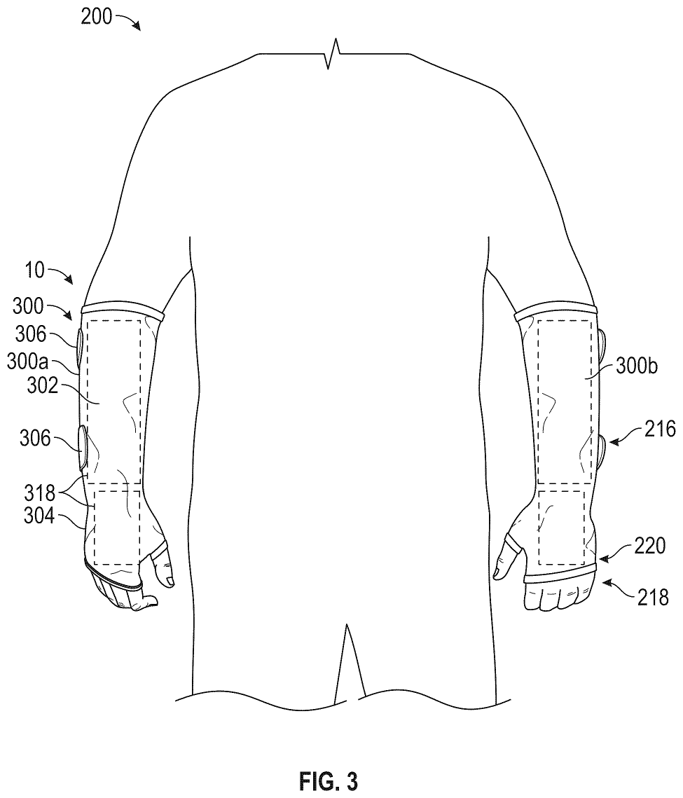

FIG. 3 is a front view of one or more radiation protection arm guards 300 for the radiation protection garment 10 worn by the user 200, according to the present disclosure. The radiation protection apron 12 and the radiation protection skirt 14 are removed in FIG. 3 for clarity. Any and all components of the radiation protection garment 10, however, can be worn by the user 200. The user 200 has forearms 216, hands 218, and knuckles 220. The one or more radiation protection arm guards 300 are configured to be worn by the user 200 on the forearms 216. For example, the one or more radiation protection arm guards 300 are configured to cover and to protect the forearms 216 of the user 200. The one or more radiation protection arm guards 300 are also configured to cover and to protect the hands 218 and the knuckles 220. The one or more radiation protection arm guards 300 include a first radiation protection arm guard 300a for a first forearm 216 of the user 200 and a second radiation protection arm guard 300b for a second forearm 216 of the user 200.

The one or more radiation protection arm guards 300 each includes a forearm portion 302 and a hand portion 304. The forearm portion 302 is sized and is shaped to cover the forearms 216 of the user 200. For example, the forearm portion 302 extends from an elbow of the user 200 to a wrist of the user 200 when the one or more radiation protection arm guards 300 are worn by the user 200. The hand portion 304 extends from the forearm portion 302 and is sized and is shaped to cover the hands 218 of the user 200. In particular, the hand portion 304 covers the knuckles 220.

The one or more radiation protection arm guards 300 include one or more arm guard fasteners 306. In FIG. 3, the one or more arm guard fasteners 306 include hook and loop fasteners, such as, for example, Velcro®. The one or more arm guard fasteners 306 can include any type of fastener for securing the one or more radiation protection arm guards 300 on the user 200, such as, for example, zippers, buttons, or the like.

The one or more radiation protection arm guards 300 include one or more lead-based panels 318. For example, the one or more radiation protection arm guards 300 include one or more of the one or more lead-based panels 318 disposed in the forearm portion 302. The one or more radiation protection arm guards 300 include one or more of the one or more lead-based panels 318 disposed in the hand portion 304. In this way, the one or more lead-based panels 318 protect the forearms 216 and the hands 218 of the user 200 from the radiation. The one or more radiation protection arm guards 300 can also include a cooling system (e.g., the cooling system 20 of FIGS. 1A and 1B).

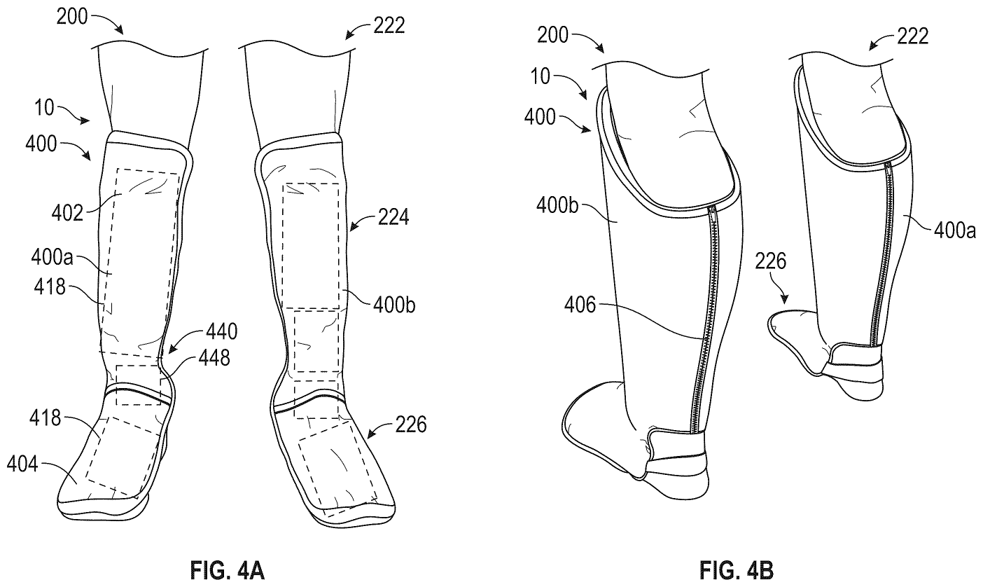

FIG. 4A is a front view of one or more radiation protection shin guards 400 for the radiation protection garment 10 worn by the user 200, according to the present disclosure. FIG. 4B is a rear view of the one or more radiation protection shin guards 400 for the radiation protection garment 10 worn by the user 200, according to the present disclosure. The radiation protection apron 12 and the radiation protection skirt 14 are not shown in the views of FIGS. 4A and 4B for clarity. The user 200 has legs 222, shins 224, and feet 226. The one or more radiation protection shin guards 400 are configured to be worn by the user 200 on the shins 224. For example, the one or more radiation protection shin guards 400 are configured to cover and to protect the shins 224 of the user 200. The one or more radiation protection shin guards 400 are also configured to cover and to protect the feet 226. The one or more radiation protection shin guards 400 include a first radiation protection shin guard 400a for a first shin 224 of the user 200 and a second radiation protection shin guard 400b for a second shin 224 of the user 200.

The one or more radiation protection shin guards 400 each includes a shin portion 402 and a foot portion 404. The shin portion 402 is sized and is shaped to cover the shins 224 of the user 200. For example, the shin portion 402 extends from a knee of the user 200 to an ankle of the user 200 when the one or more radiation protection shin guards 400 are worn by the user 200. The foot portion 404 extends from the shin portion 402 and is sized and is shaped to cover the feet 226 of the user 200.

The one or more radiation protection shin guards 400 include one or more shin guard fasteners 406 (FIG. 4B). The one or more shin guard fasteners 406 are zippers. The zippers allow the one or more radiation protection shin guards 400 to be secured to the legs 222 of the user 200. In this way, the one or more shin guard fasteners 406 are fastened and remain fastened and secured.

The one or more radiation protection shin guards 400 include one or more lead-based panels 418 (FIG. 4A). For example, the one or more radiation protection shin guards 400 include one or more of the one or more lead-based panels 418 disposed in the shin portion 402. The one or more radiation protection shin guards 400 include one or more of the one or more lead-based panels 418 disposed in the foot portion 404. In this way, the one or more lead-based panels 418 protect the shins 224 and the feet 226 of the user 200 from the radiation.

The one or more radiation protection shin guards 400 include a support system 440 including a shin guard support mechanism 448. As shown in FIG. 4A, the shin guard support mechanism 448 is located within the one or more radiation protection shin guards 400 and is an area between the shin portion 402 and the foot portion 404 when the one or more radiation protection shin guards 400 are worn by the user 200. In particular, the shin guard support mechanism 448 is located in an area of an ankle of the user 200. The shin guard support mechanism 448 rests on the feet 226 and helps to prevent the shin portion 402 from falling down the legs 222. In this way, the shin guard support mechanism 448 maintains the shin portion 402 on the shins 224 as the user 200 moves or walks around. The one or more radiation protection shin guards 400 can also include a cooling system (e.g., the cooling system 20 of FIGS. 1A and 1B).

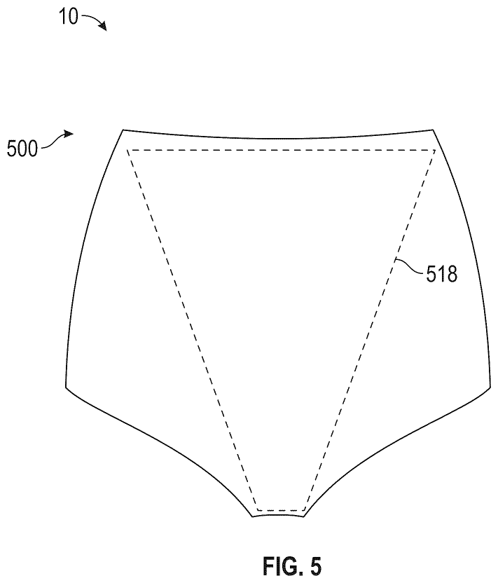

FIG. 5 is a front view of radiation protection underwear 500 for the radiation protection garment 10, according to the present disclosure. The radiation protection underwear 500 includes one or more lead-based panels 518. The one or more lead-based panels 518 are disposed within the radiation protection underwear 500. The one or more lead-based panels 518 in the radiation protection underwear 500 are generally triangular shaped and extend from a front of the radiation protection underwear 500 to a rear side of the radiation protection underwear 500. In this way, the radiation protection underwear 500 protects genitals of the user 200 from the radiation. In particular, the radiation protection underwear 500 protects the genitals from scatter radiation that reflects off the ground and towards the user's underside. The radiation protection underwear 500 can also include a cooling system (e.g., the cooling system 20 of FIGS. 1A and 1B).

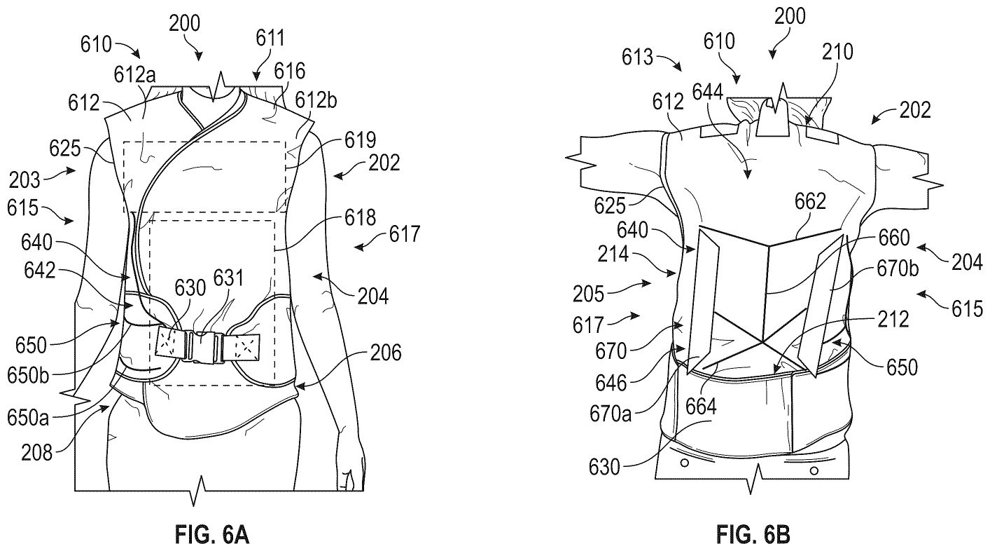

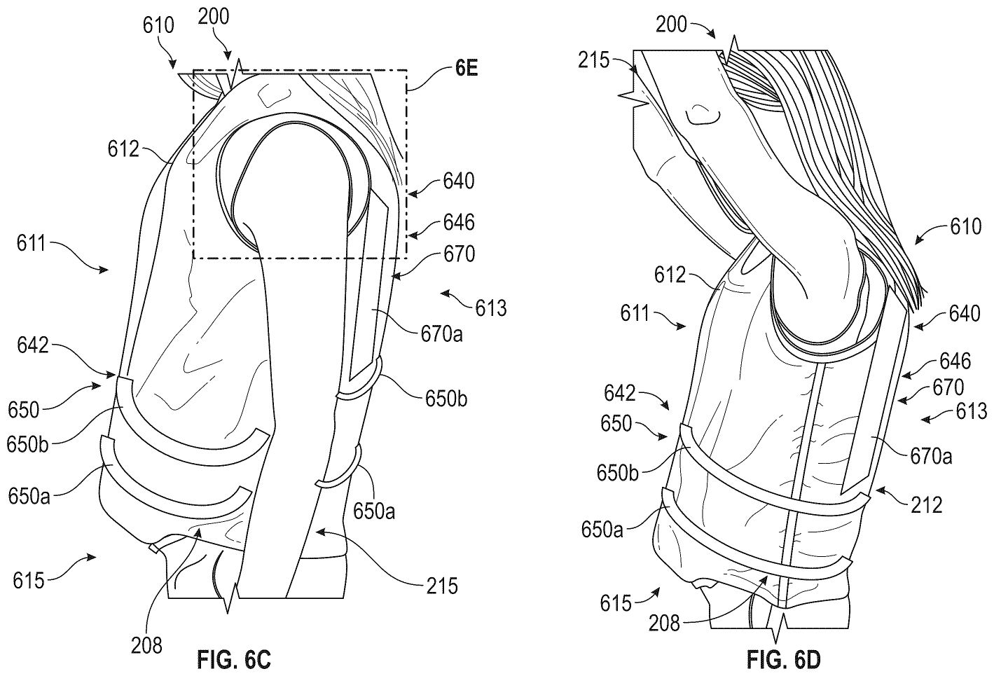

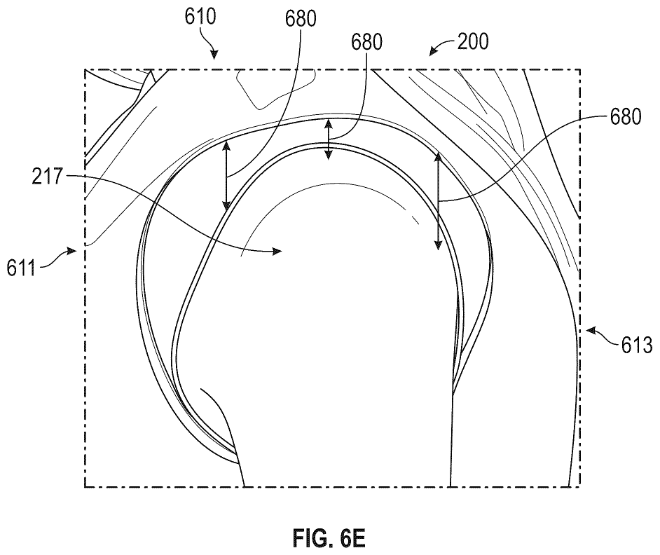

FIG. 6A illustrates a schematic, front view of a radiation protection garment 610 in a closed state and worn by the user 200, according to another embodiment. FIG. 6B illustrates a schematic, rear view of the radiation protection garment 610 in the closed state and worn by the user 200, according to the present disclosure. FIG. 6C illustrates a schematic, side view of the radiation protection garment 610 in the closed state and worn by the user 200 with arms 215 lowered, according to the present disclosure. FIG. 6D illustrates a schematic, side view of the radiation protection garment 610 in the closed state and worn by the user 200 with the arms 215 raised, according to the present disclosure. The radiation protection garment 610 includes a radiation protection apron 612 including a first apron flap 612a and a second apron flap 612b that overlap each other when the radiation protection apron 612 is in the closed state, as shown in FIG. 6A. Although not shown, the radiation protection garment 610 can also include a radiation protection skirt, such as, the radiation protection skirt 14 of FIGS. 1A and 1B. The radiation protection garment 610 includes a front side 611 (FIG. 6A), a rear side 613 (FIG. 6B), a left side 615 (FIGS. 6C and 6D), and a right side 617 (FIGS. 6A and 6B).

The radiation protection garment 610 includes an outer layer 616 that contains one or more lead-based panels 618 (shown schematically by dashed lines in FIG. 6) therein for protection against radiation. The lead-based panels 618 include one or more chest lead-based panels 619 disposed in an upper chest area of the user. The one or more chest lead-based panels 619 in the upper chest area extend laterally outward to cover an entirety of the user's breasts. For example, the one or more chest lead-based panels 619 in the upper chest area extend along an entire length of the user's clavicle. In this way, the one or more chest lead-based panels 619 cover the breasts even when the user moves, thereby protecting the breasts from the harmful radiation. In this way, the breasts do not become exposed as the breasts do with current radiation protection garments without the benefit of the present disclosure. In some embodiments, the lead-based panels 618 can be disposed on the rear side 613 for additional radiation protection on the rear side 613. For example, the lead-based panels 618 can be positioned on the rear side 613 at the cervical neck 210 of the user 200. Although not shown, the radiation protection garment 610 can include a cooling system (e.g., the cooling system 20 of FIGS. 1A and 1B) for cooling a user while the user is wearing the radiation protection garment 610.

The radiation protection apron 612 includes a convex sleeve portion 625 that extends generally laterally from the front side 11. The convex sleeve portion 625 provides additional material such that the one or more chest lead-based panels 619 can extend across an entirety of the breasts of the user. In this way, the radiation protection apron 612 protects the breasts from being exposed when worn by the user as compared to radiation protection aprons without the benefit of the present disclosure.

The radiation protection garment 610 also includes an expandable belt 630. The expandable belt 630 expands and retracts such that the radiation protection garment 610 fits users of various sizes. The expandable belt 630 includes a belt fastener 631 for fastening the expandable belt 630 on the user 200. The belt fastener 631 is a side release buckle that include a male component inserted into a female component. The belt fastener 631 can include any type of fastener for securing the expandable belt 630 together. The expandable belt 630 is angled at an angle greater than zero from the rear side 613 (FIG. 6B) to the front side 611. In this way, the expandable belt 630 rests on the waist and the hips of the user 200 when the expandable belt 630 is secured.

The radiation protection garment 610 includes a support system 640 as shown in FIGS. 6A to 6D. The support system 640 and components of the support system 640 are shown schematically in FIGS. 6A to 6D and are shown on the outside of the radiation protection garment 610 for illustration purposes. The support system 640 can be disposed within the radiation protection garment 610. The support system 640 supports the weight of the radiation protection garment 610 and reduces the pressure from the cervical spine 210 and/or the lumbosacral region 212 of the user 200 as compared to radiation protection garments without the benefit of the present disclosure. The expandable belt 630 is coupled to, or otherwise extends from, the support system 640. In this way, the expandable belt 630 helps to lift the support system 640 up when the expandable belt 630 is secured such that the radiation protection apron 612 is lifted off of the shoulders of the user 200 to reduce the pressure on the shoulders, as detailed further below. The support system 640 includes one or more support mechanisms that are rigid support structures, such as, for example, rods, plates, or the like. The one or more support mechanisms can be made from a lightweight metal, ceramic, or the like. The support system 640 includes a first support mechanism 642 (FIGS. 6A, 6C, and 6D), a second support mechanism 644 (FIG. 6B), and a third support mechanism 646 (FIGS. 6B to 6D).

As shown in FIGS. 6A, 6C, and 6D, the first support mechanism 642 is located within the radiation protection apron 612 and is an area of the bilateral iliac crest 208 when the radiation protection apron 612 is worn by the user 200. The first support mechanism 642 helps to alleviate pressure on the bilateral iliac crest 208 of the user 200 to help redirect the distribution of the weight of the radiation protection garment 610 away from the user's back (e.g., the cervical spine 210 and/or the lumbosacral region 212). As shown in FIG. 6B, the second support mechanism 644 is positioned on the rear side 613 of the radiation protection apron 612 and includes an indentation to provide support on the lumbosacral region 212. The indentation has a slight curvature such that the radiation protection apron 612 conforms to the curvature of the lumbosacral region 212, thereby alleviating pressure on the lumbosacral region 212. As shown in FIGS. 6B to 6D, the third support mechanism 646 is located on the left side 615 and the right side 617 of the radiation protection apron 12 along the midaxillary line 214 when the radiation protection apron 612 is worn by the user 200. The third support mechanism 646 extends longitudinally along the midaxillary line 214 and accommodates the weight of the radiation protection apron 612 and removes pressure from the cervical spine 210.

The first support mechanism 642 includes one or more circumferential support mechanisms 650 disposed in, and extending circumferentially about, the radiation protection apron 612. The one or more circumferential support mechanisms 650 support the radiation protection garment 610 at the pelvis 206 (e.g., the bilateral iliac crest 208) of the user 200. FIG. 6A shows only a portion of the one or more circumferential support mechanisms 650. As shown in FIGS. 6C and 6D, the one or more circumferential support mechanisms 650 can extend substantially an entire circumference of the radiation protection apron 612 when the radiation protection apron 612 is in the closed state. The one or more circumferential support mechanisms 650 include a first circumferential support mechanism 650a and a second circumferential support mechanism 650b. The first circumferential support mechanism 650a is positioned approximately at a waist of the user 200 when the radiation protection apron 612 is worn by the user 200. The second circumferential support mechanism 650b is positioned approximately at the bilateral iliac crest 208 of the user 200 when the radiation protection apron 612 is worn by the user 200. In this way, the one or more circumferential support mechanisms 650 support the radiation protection apron 612 at the user's waist and hips. Accordingly, the one or more circumferential support mechanisms 650 help to distribute a weight of the radiation protection apron 612 onto the user's waist and hips and away from the user's back and shoulders.

The second support mechanism 644 (FIG. 6B) includes one or more vertical support mechanisms 660, one or more horizontal support mechanisms 662, and one or more oblique support mechanisms 664. The one or more vertical support mechanisms 660 extend generally vertically within the radiation protection apron 612 and are positioned approximately in a lateral center of the rear side 613 of the radiation protection apron 612. In this way, the one or more vertical support mechanisms 660 extend along the user's spine when the radiation protection apron 612 is worn by the user 200. The one or more vertical support mechanisms 660 are disposed generally parallel to a plane defined by the outer layer 616 of the radiation protection apron 612. The one or more vertical support mechanisms 660 are positioned approximately at a longitudinal center of the rear side 613 of the radiation protection apron 612 and extend partially between a top of the radiation protection apron 612 and a bottom of the radiation protection apron 612. While one vertical support mechanism 660 is shown in FIG. 6B, the one or more vertical support mechanisms 660 can include any number of vertical support mechanisms 660 for supporting the weight of the radiation protection apron 612.

The one or more horizontal support mechanisms 662 extend generally horizontally within the radiation protection apron 612 and are positioned approximately at a top end of the one or more vertical support mechanisms 660. The one or more horizontal support mechanisms 662 extend from the one or more vertical support mechanisms 660 towards the left side 615 and towards the right side 617 of the radiation protection apron 612. In this way, the one or more horizontal support mechanisms 662 extend from the left side 615 to the right side 617 of the rear side 613 of the radiation protection apron 612. The one or more horizontal support mechanisms are disposed generally parallel to the plane defined by the outer layer 616 of the radiation protection apron 612. The one or more horizontal support mechanisms 662 are disposed between the midaxillary line 214 of the left side 615 and the midaxillary line 214 of the right side 617. While one horizontal support mechanism 662 is shown in FIG. 6B, the one or more horizontal support mechanisms 662 can include any number of horizontal support mechanisms 662 for supporting the weight of the radiation protection apron 612.

The one or more oblique support mechanisms 664 extend generally at an angle (e.g., slanted) with respect to the one or more vertical support mechanisms 660. In this way, the one or more oblique support mechanisms 664 extend at angle greater than zero with respect to the plane defined by the outer layer 616 of the radiation protection apron 612. The one or more oblique support mechanisms 664 extend from the left side 615 to the right side 617 of the rear side 613 and from the rear side 613 towards the front side 611 of the radiation protection apron 612. The one or more oblique support mechanisms 664 are disposed between the midaxillary line 214 of the left side 615 and the midaxillary line 214 of the right side 617. The one or more oblique support mechanisms 664 are positioned generally at a bottom end of the vertical support mechanisms 660 and extend from the one or more vertical support mechanisms 660. While two oblique support mechanisms 664 are shown in FIG. 6B, the one or more oblique support mechanisms 664 can include any number of oblique support mechanisms 664 for supporting the weight of the radiation protection apron 612. The one or more vertical support mechanisms 660, the one or more horizontal support mechanisms 662, and the one or more oblique support mechanisms 664 together provide the indentation to provide support on the lumbosacral region 212 of the user 200. The second support mechanism 644 thereby alleviates pressure on the lumbosacral region 212.

The third support mechanism 646 (FIGS. 6B to 6D) includes one or more posterior vertical support mechanisms 670 disposed, and extending vertically, in the radiation protection apron 612. The one or more posterior vertical support mechanisms 670 are positioned on the rear side 613 of the radiation protection apron 612 and support the weight of the radiation protection apron 612 to reduce a pressure on the cervical spine 210 of the user 200. The one or more posterior vertical support mechanisms 670 are positioned generally along the midaxillary line 214 on the rear side 613. The one or more posterior vertical support mechanisms 670 include a first posterior vertical support mechanism 670a and a second posterior vertical support mechanism 670b. The first posterior vertical support mechanism 670a is positioned on the right side 617 of the rear side 613 of the radiation protection apron 612. The second posterior vertical support mechanism 670b is positioned on the left side 615 of the rear side 613 of the radiation protection apron 612. In this way, the first posterior vertical support mechanism 670a is located on the right side 617 of the radiation protection apron 12 along the midaxillary line 214 when the radiation protection apron 612 is worn by the user 200. The second posterior vertical support mechanism 670b is located on the left side 615 of the radiation protection apron 12 along the midaxillary line 214 when the radiation protection apron 612 is worn by the user 200. The second support mechanism 644 is disposed between, and extends from, the first posterior vertical support mechanism 670a and the second posterior vertical support mechanism 670b. For example, the one or more horizontal support mechanisms 662 and the one or more oblique support mechanisms 664 extend from the first posterior vertical support mechanism 670a and the second posterior vertical support mechanism 670b. As shown in FIGS. 6C and 6D, the one or more circumferential support mechanisms 650 support the one or more posterior vertical support mechanisms 670. Accordingly, the third support mechanism 646 extends longitudinally along the midaxillary line 214 and accommodates the weight of the radiation protection apron 612 and removes pressure from the cervical spine 210.

The support system 640 and the expandable belt 630 (FIGS. 6A to 6D) help to distribute the weight of the radiation protection garment 610 when worn by the user 200 so the pressure is distributed away from the lumbosacral region 212. For example, the support system 640 and the expandable belt 630 distribute the pressure laterally across the user's back and toward the bilateral iliac crest 208. Accordingly, the support system 640 and the expandable belt 630 help to alleviate the pressure away from the cervical spine 210 and distribute the weight of the radiation protection garment 610 toward the bilateral iliac crest 208 and/or the lumbosacral region 212. In this way, the support system 640 and the expandable belt 630 help to alleviate discomfort, injury, and/or existing injuries (e.g., cervical anatomical medical conditions). The support system 640 and the expandable belt 630 can also be configured to distribute the pressure to areas away from the lumbosacral region 212 and toward the bilateral iliac crest 208 and/or the midaxillary line 214 and toward the abdominal wall of the user 200. In this way, the weight is distributed away from the vertebrae and is directed laterally outward on the torso 204 and redirected toward the user's shoulders. The third support mechanism 646 accommodates the weight on the midaxillary line 214. Accordingly, the support system 640 and the expandable belt 630 help to substantially reduce or remove the pressure from the cervical spine 210 as compared to radiation protection garments without the benefit of the present disclosure.

With reference to FIGS. 6A-6D, in operation, the user 200 wears the radiation protection garment 610. The expandable belt 630 is adjusted to fit the around the user's waist and placed around the user's waist. The expandable belt 630 is then secured to secure the radiation protection garment 610 on the user 200. The support system 640 and the expandable belt 630 help to distribute the weight of the radiation protection garment 610, as detailed above.

The radiation protection garment 610 may cause the user 200 to perspire and sweat while the user 200 is wearing the radiation protection garment 610. The cooling system (e.g., the cooling system 20 of FIGS. 1A-1B) helps to cool the user 200 while the user 200 is wearing the radiation protection garment 610, as detailed above.

FIG. 6E is an enlarged, schematic, side view of the radiation protection garment 610, taken at detail 6E in FIG. 6C, according to the present disclosure. As shown in FIG. 6E, the support system 640 helps to lift the radiation protection apron 612 off of the shoulders 217 of the user 200. In this way, the support system 640 removes the weight of the radiation protection apron 612 from the shoulders 217 of the user 200, thereby reducing a pressure on the shoulders 217. For example, the support system 640 generates a gap 680 between the shoulders 217 of the user 200 and the radiation protection apron 612. The gap 680 is maintained when the user 200 moves their arms 215 (FIG. 6D).

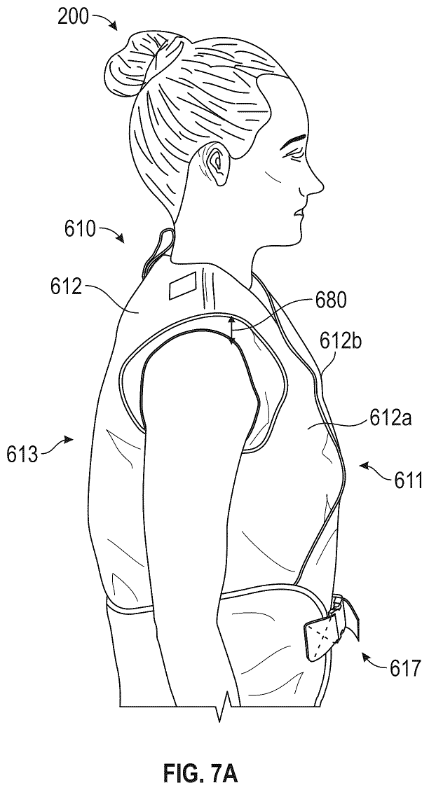

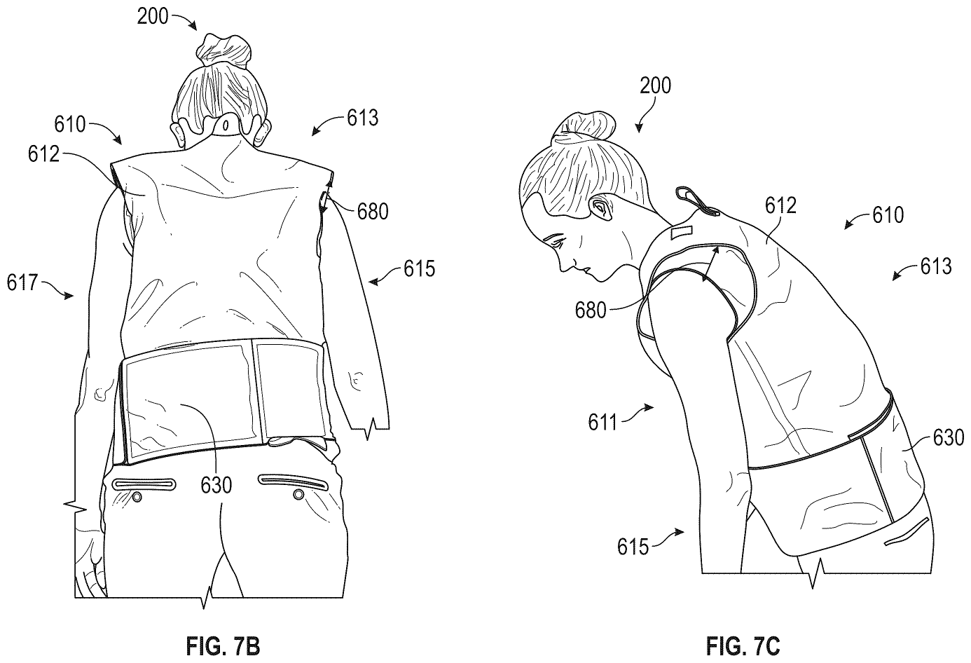

FIGS. 7A to 7C illustrate a range of motion of the user 200 while the radiation protection apron 612 maintains the gap 680, according to the present disclosure. FIG. 7A is a schematic right side view of the user 200 wearing the radiation protection apron 612 and the user is standing straight up. FIG. 7B is a schematic rear view of the user 200 wearing the radiation protection apron 612 and the user 200 is bent over. FIG. 7C is a schematic left side view of the user 200 wearing the radiation protection apron 612 and the user 200 is bent over. As shown in FIGS. 7A to 7C, the gap 680 is maintained regardless of how the user 200 is moving (e.g., standing straight up, bending over, moving the arms 215, etc.). The gap 680 may change in size while the user 200 moves, but the gap 680 exists regardless of how the user 200 is moving. Accordingly, the radiation protection apron 612 does not rest on the shoulders 217 of the user 200 and the support system 640 of the radiation protection apron 612 distributes the weight of the radiation protection apron 612 away from the shoulders 217, thereby relieving the pressure on the shoulders 217 as compared to radiation protection aprons without the benefit of the present disclosure.

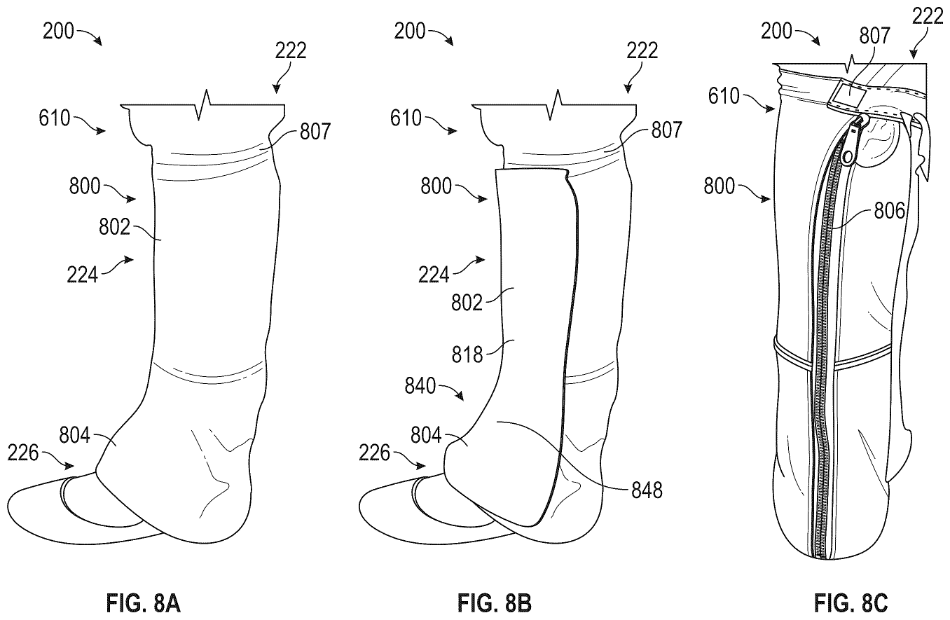

FIG. 8A is a schematic side view of one or more radiation protection shin guards 800 for the radiation protection garment 610 worn by the user 200, according to another embodiment. FIG. 8B is a schematic side view of the one or more radiation protection shin guards 800 for the radiation protection garment 610 worn by the user 200, according to the present disclosure. FIG. 8C is a schematic rear view of the one or more radiation protection shin guards 800 for the radiation protection garment 610 worn by the user 200, according to the present disclosure. The radiation protection apron 612 and the radiation protection skirt are not shown in the views of FIGS. 8A to 8C for clarity. The one or more radiation protection shin guards 800 are configured to be worn by the user 200 on the shins 224. For example, the one or more radiation protection shin guards 800 are configured to cover and to protect the shins 224 of the user 200. The one or more radiation protection shin guards 800 are also configured to cover and to protect the feet 226.

The one or more radiation protection shin guards 800 each includes a shin portion 802 and a foot portion 804. The shin portion 802 is sized and is shaped to cover the shins 224 of the user 200. For example, the shin portion 802 extends from a knee of the user 200 to an ankle of the user 200 when the one or more radiation protection shin guards 800 are worn by the user 200. The foot portion 804 extends from the shin portion 802 and is sized and is shaped to cover a portion of the feet 226 of the user 200. For example, the foot portion 804 covers a top of the feet 226 and extends approximately one-third of the feet 226 from the shin portion 802.

The one or more radiation protection shin guards 800 include one or more shin guard fasteners 806 (FIG. 8C). The one or more shin guard fasteners 806 are zippers. The zippers allow the one or more radiation protection shin guards 800 to be secured to the legs 222 of the user 200. In this way, the one or more shin guard fasteners 806 are fastened and remain fastened and secured. The one or more radiation protection shin guards 800 include one or more shin guard straps 807. The one or more shin guard straps 807 include hook and loop fasteners (e.g., Velcro®) and can be tightened to be secured about the leg 222 of the user 200. In this way, the one or more shin guard straps 807 are adjustable such that the one or more radiation protection shin guards 800 are sized to fit various leg sizes for different users. The one or more shin guard fasteners 806 allow for ease of placement of the one or more radiation protection shin guards 800 on the legs 222 and also helps to support the one or more shin guard straps 807. In this way, the one or more shin guard fasteners 806 and the one or more shin guard straps 807 help to secure and to maintain the one or more radiation protection shin guards 800 on the legs 222 without sliding down the legs 222.

The one or more radiation protection shin guards 800 include one or more lead-based panels 818 (FIG. 8B). The one or more lead-based panels 818 are shown schematically in FIG. 8B and is shown on the outside of the one or more radiation protection shin guards 800 for illustration purposes. The one or more lead-based panels 818 can be disposed within the one or more radiation protection shin guards. For example, the one or more radiation protection shin guards 800 include one or more of the one or more lead-based panels 818 disposed in the shin portion 802. The one or more radiation protection shin guards 800 include one or more of the one or more lead-based panels 818 disposed in the foot portion 804. In this way, the one or more lead-based panels 818 protect the shins 224 and the feet 226 of the user 200 from the radiation. In the embodiment of FIGS. 8A to 8C, the one or more of the one or more lead-based panels 818 includes one lead-based panel 818 that is shaped and is sized to cover the shin 224 and the feet 226 of the user 200. The one or more radiation protection shin guards 800 can include any number of lead-based panels 818.

The one or more radiation protection shin guards 800 include a support system 840 including a shin guard support mechanism 848. As shown in FIG. 8B, the shin guard support mechanism 848 is located within the one or more radiation protection shin guards 800 and is an area between the shin portion 802 and the foot portion 804 when the one or more radiation protection shin guards 800 are worn by the user 200. In particular, the shin guard support mechanism 848 is located in an area of an ankle of the user 200. The shin guard support mechanism 848 rests on the feet 226 and helps to prevent the shin portion 802 from falling down the legs 222. In this way, the shin guard support mechanism 848 maintains the shin portion 802 on the shins 224 as the user 200 moves or walks around. The one or more radiation protection shin guards 800 can also include a cooling system (e.g., the cooling system 20 of FIGS. 1A and 1B).

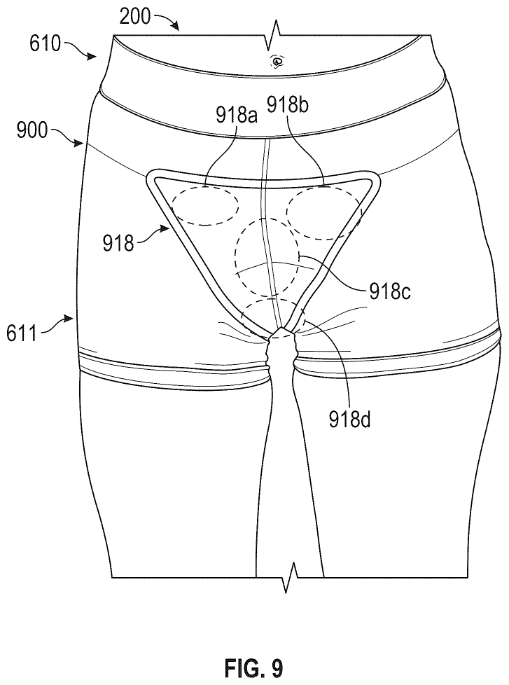

FIG. 9 is a schematic front view of radiation protection underwear 900 for the radiation protection garment 610, according to another embodiment. The radiation protection underwear 900 includes one or more lead-based panels 918. The one or more lead-based panels 918 are shown schematically in FIG. 9 and are shown on the outside of the radiation protection underwear 900 for illustration purposes. The one or more lead-based panels 918 can be disposed within the one or more radiation protection shin guards. The one or more lead-based panels 918 are disposed within the radiation protection underwear 900. The one or more lead-based panels 918 in the radiation protection underwear 900 are generally triangular shaped. In FIG. 9, the one or more lead-based panels 918 include one lead-based panel 918 that extends from the front side 611 (e.g., anterior) of the radiation protection underwear 900 to the rear side 613 (e.g., posterior) of the radiation protection underwear 900. The one or more lead-based panels 918 extend from a lower abdomen of the user 200, over the genitals of the user 200, and to the rear side 613 of the user 200. In this way, the radiation protection underwear 900 protects genitals of the user 200 from the radiation. In particular, the radiation protection underwear 900 protects the genitals from scatter radiation that reflects off the ground and towards the user's underside (e.g., regardless of the direction of the source of the radiation) and also protects from direct radiation. The one or more lead-based panels 918 are sized and are shaped to cover a right ovary region 918a (e.g., right ovary and surrounding tissue) of the user 200, a left ovary region 918b (e.g., left ovary and surrounding tissue) of the user 200, uterus region 918c (e.g., uterus and fallopian tube and surrounding tissue) of the user 200, and a genital region 918d (e.g., vagina) of the user 200. While female anatomy is detailed herein, the one or more lead-based panels 918 also cover male genitalia (e.g., penis, scrotum, and testicles) when the radiation protection underwear 900 is worn by a male user. The radiation protection underwear 900 can also include a cooling system (e.g., the cooling system 20 of FIGS. 1A and 1B).

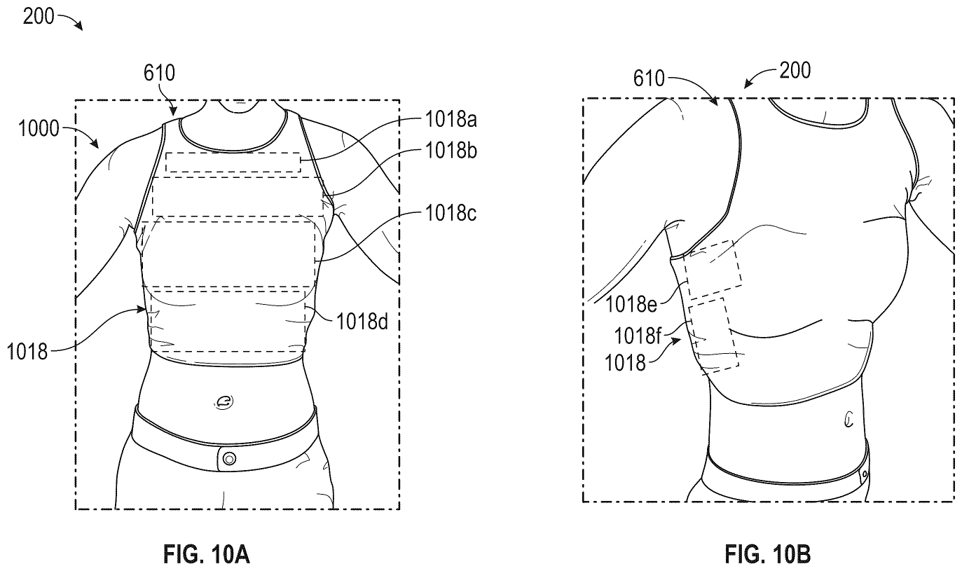

FIG. 10A illustrates a schematic front view of a radiation protection undergarment 1000 for the radiation protection garment 610, according to the present disclosure. FIG. 10B illustrates a schematic front side view of the radiation protection undergarment 1000 for the radiation protection garment 610, according to the present disclosure. The radiation protection undergarment 1000 is a brassiere (bra) that extends to a midriff of the user 200. The radiation protection undergarment 1000 includes one or more lead-based panels 1018. The one or more lead-based panels 1018 are disposed within the radiation protection undergarment 1000. In FIG. 10A, the one or more lead-based panels 1018 include four lead-based panels 1018. The one or more lead-based panels 1018 can include any number of lead-based panels 1018 that cover the chest and upper abdomen of the user 200. The one or more lead-based panels 1018 extend laterally across the front side 611 to cover the front side 611 from the midaxillary line 214 of the left side 615 to the midaxillary line 214 of the right side 617. As shown in FIG. 10A, the one or more lead-based panels 1018 extend to cover an upper chest tissue region 1018a, an anterior axillary tissue region 1018b, a mid-chest axillary tissue region 1018c, and an upper abdominal tissue region 1018d. As shown in FIG. 10B, the one or more lead-based panels 1018 extend to cover a mid-axillary tissue region 1018e and a back tissue region 1018f. The radiation protection undergarment 1000 can also include a cooling system (e.g., the cooling system 20 of FIGS. 1A and 1B).

Accordingly, the radiation protection garment 10, 610 of the present disclosure provides for a support system 40, 640 that distributes the weight of the radiation protection garment 10, 610 away from the user's cervical spine and lower back, while also cooling the user 200 with a cooling system 20. The radiation protection garment 10, 610 also provides for a reduced amount of lead within the radiation protection garment 10, 610 as compared to current radiation protection garments while complying with regulations such that the lead-based panels 18, 318, 418, 518, 618, 818, 918, 1018 provide full protection from harmful radiation during, for example, x-ray procedures. In this way, the radiation protection garment 10, 610 provides for an improved radiation protection garment, as compared to current radiation protection garments, that includes a reduced weight, a support system for reducing the pressure on the cervical spine and lower back of the user, an expandable belt 30, 630 that allows the radiation protection garment 10, 610 to fit users of various sizes without having to measure the user 200 while maintaining radiation protection, and a cooling system 20 that helps to keep the user 200 cool while the user 200 is wearing the radiation protection garment 10, 610.

Further aspects are provided by the subject matter of the following clauses.

A radiation protection garment comprising: one or more lead-based panels; and a cooling system comprising: one or more air flow paths, the one or more air flow paths containing air; and one or more air vents that provide fluid communication between atmosphere and the one or more air flow paths, wherein movement of the radiation protection garment causes the air in the one or more air flow paths to flow through the one or more air flow paths.

The radiation protection garment of the preceding clause, wherein movement of the radiation protection garment causes ambient air to flow into the one or more air flow paths through the one or more air vents.

The radiation protection garment of any preceding clause, wherein the air within the one or more air flow paths includes cool air that mixes with warm air within the one or more air flow paths as the air flows through the one or more air flow paths.

The radiation protection garment of any preceding clause, wherein the one or more air flow paths are located on at least one of a front side, a rear side, a left side, or a right side of the radiation protection garment.

The radiation protection garment of any preceding clause, wherein the one or more air vents are located on the at least one of the front side, the rear side, the left side, or the right side of the radiation protection garment.

The radiation protection garment of any preceding clause, wherein the one or more air vents are unaligned with each other when the radiation protection garment is in a closed state.

The radiation protection garment of any preceding clause, further comprising an expandable belt that expands and retracts such that the radiation protection garment fits users of various sizes.

The radiation protection garment of any preceding clause, wherein the expandable belt comprises one or more lead strips and an elastic material looped together to form the expandable belt.

The radiation protection garment of any preceding clause, further comprising a support system that distributes a weight of the radiation protection garment away from at least one of a neck or a lower back of a user while the user is wearing the radiation protection garment.

The radiation protection garment of any preceding clause, wherein the support system comprises a first support mechanism located in an area of a bilateral iliac crest of the user when the user is wearing the radiation protection garment, the first support mechanism at least partially supporting the weight of the radiation protection garment at the bilateral iliac crest of the user.

The radiation protection garment of any preceding clause, wherein the first support mechanism includes one or more circumferential support mechanisms that extend circumferentially about the radiation protection garment.

The radiation protection garment of any preceding clause, wherein the support system comprises a second support mechanism located on a rear side of the radiation protection garment to distribute the weight of the radiation protection garment away from a lumbosacral region of the user.

The radiation protection garment of any preceding clause, wherein the second support mechanism includes one or more vertical support mechanisms, one or more horizontal support mechanisms, and one or more oblique support mechanisms.

The radiation protection garment of any preceding clause, wherein the second support mechanism includes an indentation having a curvature that conforms the radiation protection garment to the lumbosacral region of the user.

The radiation protection garment of any preceding clause, wherein the support system includes a third support mechanism located on at least one of a left side or a right side of midaxillary line of the user while the user is wearing the radiation protection garment such that the third support mechanism at least partially supports the weight of the radiation protection garment at the midaxillary line of the user.

The radiation protection garment of any preceding clause, wherein the third support mechanism includes one or more posterior vertical support mechanisms.

The radiation protection garment of any preceding clause, wherein the radiation protection garment includes at least one of a radiation protection apron or a radiation protection skirt.

The radiation protection garment of any preceding clause, wherein the radiation protection apron includes a first apron flap and a second apron flap, the first apron flap overlaps the second apron flap on a front side of the radiation protection apron when the radiation protection apron is in the closed state.

The radiation protection garment of any preceding clause, wherein the first apron flap includes one or more of the one or more lead-based panels and the second apron flap includes one or more of the lead-based panels.

The radiation protection garment of any preceding clause, wherein the radiation protection apron includes an outwardly curved collar portion that extends forward from a front side of the radiation protection apron.

The radiation protection garment of any preceding clause, wherein the one or more lead-based panels include one or more chest lead-based panels in a chest area of the radiation protection apron, and the one or more chest lead-based panels extend laterally outwardly to cover breasts of a user.

The radiation protection garment of any preceding clause, further comprising at least one of a radiation protection shin guard, a radiation protection arm guard, a radiation protection neck guard, or a radiation protection head guard.

The radiation protection garment of any preceding clause, wherein the radiation protection shin guard includes a shin portion that covers a shin of a user, a foot portion that covers a foot of the user, and a support mechanism disposed between the shin portion and the foot portion that supports the shin portion on the foot portion.

The radiation protection garment of any preceding clause, wherein the radiation protection shin guard includes one or more zippers for securing the radiation protection shin guard on the user.

The radiation protection garment of any preceding clause, wherein the radiation protection arm guard includes a forearm portion that covers a forearm of a user and a hand portion that extends from the forearm portion and covers a hand of the user.

The radiation protection garment of any preceding clause, further comprising a radiation protection undergarment.

The radiation protection garment of any preceding clause, wherein the radiation protection undergarment comprises at least one of a radiation protection brassiere or a radiation protection underwear.

The radiation protection garment of any preceding clause, wherein the radiation protection underwear includes one or more of the one or more lead-based panels.

A radiation protection garment comprising: one or more lead-based panels; and a support system that distributes a weight of the radiation protection garment away from at least one of a neck or a lower back of a user while the user is wearing the radiation protection garment.

The radiation protection garment of the preceding clause, wherein the support system comprises a first support mechanism located in an area of a bilateral iliac crest of the user when the user is wearing the radiation protection garment, the first support mechanism at least partially supporting the weight of the radiation protection garment at the bilateral iliac crest of the user.

The radiation protection garment of any preceding clause, wherein the first support mechanism includes one or more circumferential support mechanisms that extend circumferentially about the radiation protection garment.

The radiation protection garment of any preceding clause, wherein the support system comprises a second support mechanism located on a rear side of the radiation protection garment to distribute the weight of the radiation protection garment away from a lumbosacral region of the user.

The radiation protection garment of any preceding clause, wherein the second support mechanism includes one or more vertical support mechanisms, one or more horizontal support mechanisms, and one or more oblique support mechanisms.

The radiation protection garment of any preceding clause, wherein the second support mechanism includes an indentation having a curvature that conforms the radiation protection garment to the lumbosacral region of the user.

The radiation protection garment of any preceding clause, wherein the support system includes a third support mechanism located on at least one of a left side or a right side of midaxillary line of the user while the user is wearing the radiation protection garment such that the third support mechanism at least partially supports the weight of the radiation protection garment at the midaxillary line of the user.

The radiation protection garment of any preceding clause, wherein the third support mechanism includes one or more posterior vertical support mechanisms.

The radiation protection garment of any preceding clause, further comprising a cooling system comprising: one or more air flow paths, the one or more air flow paths containing air; and one or more air vents that provide fluid communication between atmosphere and the one or more air flow paths, wherein movement of the radiation protection garment causes the air in the one or more air flow paths to flow through the one or more air flow paths and exit through the one or more air vents.

The radiation protection garment of any preceding clause, wherein movement of the radiation protection garment causes ambient air to flow into the one or more air flow paths through the one or more air vents.

The radiation protection garment of any preceding clause, wherein the air within the one or more air flow paths includes cool air that mixes with warm air within the one or more air flow paths as the air flows through the one or more air flow paths.

The radiation protection garment of any preceding clause, wherein the one or more air flow paths are located on at least one of a front side, a rear side, a left side, or a right side of the radiation protection garment.

The radiation protection garment of any preceding clause, wherein the one or more air vents are located on the at least one of the front side, the rear side, the left side, or the right side of the radiation protection garment.

The radiation protection garment of any preceding clause, wherein the one or more air vents are unaligned with each other when the radiation protection garment is in a closed state.

The radiation protection garment of any preceding clause, further comprising an expandable belt that expands and retracts such that the radiation protection garment fits users of various sizes.

The radiation protection garment of any preceding clause, wherein the expandable belt comprises one or more lead strips and an elastic material looped together to form the expandable belt.

The radiation protection garment of any preceding clause, wherein the radiation protection garment includes at least one of a radiation protection apron or a radiation protection skirt.

The radiation protection garment of any preceding clause, wherein the radiation protection apron includes a first apron flap and a second apron flap, the first apron flap overlaps the second apron flap on a front side of the radiation protection apron when the radiation protection apron is in the closed state.

The radiation protection garment of any preceding clause, wherein the first apron flap includes one or more of the one or more lead-based panels and the second apron flap includes one or more of the lead-based panels.

The radiation protection garment of any preceding clause, wherein the radiation protection apron includes an outwardly curved collar portion that extends forward from a front side of the radiation protection apron.

The radiation protection garment of any preceding clause, wherein the one or more lead-based panels include one or more chest lead-based panels in a chest area of the radiation protection apron, and the one or more chest lead-based panels extend laterally outwardly to cover breasts of a user.

The radiation protection garment of any preceding clause, further comprising at least one of a radiation protection shin guard, a radiation protection arm guard, a radiation protection neck guard, or a radiation protection head guard.

The radiation protection garment of any preceding clause, wherein the radiation protection shin guard includes a shin portion that covers a shin of a user, a foot portion that covers a foot of the user, and a support mechanism disposed between the shin portion and the foot portion that supports the shin portion on the foot portion.

The radiation protection garment of any preceding clause, wherein the radiation protection shin guard includes one or more zippers for securing the radiation protection shin guard on the user.

The radiation protection garment of any preceding clause, wherein the radiation protection arm guard includes a forearm portion that covers a forearm of a user and a hand portion that extends from the forearm portion and covers a hand of the user.

The radiation protection garment of any preceding clause, further comprising a radiation protection undergarment.

The radiation protection garment of any preceding clause, wherein the radiation protection undergarment comprises at least one of a radiation protection brassiere or a radiation protection underwear.

The radiation protection garment of any preceding clause, wherein the radiation protection underwear includes one or more of the one or more lead-based panels.

A radiation protection garment comprising one or more radiation protection arm guards, the one or more radiation protection arm guards comprising a forearm portion that covers a forearm of a user and a hand portion that extends from the forearm portion and covers a hand of the user.

The radiation protection garment of the preceding clause, the radiation protection garment including the radiation protection garment of any preceding clause.

A radiation protection garment comprising one or more radiation protection shin guards comprising a shin portion that covers a shin of a user, a foot portion that covers a foot of the user, and a support mechanism disposed between the shin portion and the foot portion that supports the shin portion on the foot portion.

The radiation protection garment of any preceding clause, wherein the radiation protection shin guard includes one or more zippers for securing the radiation protection shin guard on the user.

The radiation protection garment of the preceding clause, the radiation protection garment including the radiation protection garment of any preceding clause.

A radiation protection garment comprising a radiation protection underwear comprising one or more of the one or more lead-based panels.

The radiation protection garment of the preceding clause, the one or more of the one or more lead-based panels being generally triangular shaped.

The radiation protection garment of the preceding clause, the radiation protection garment including the radiation protection garment of any preceding clause.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A radiation protection garment comprising:
one or more lead-based panels; and
a cooling system comprising:
one or more air flow paths, the one or more air flow paths containing air; and
one or more air vents that provide fluid communication between atmosphere and the one or more air flow paths, wherein movement of the radiation protection garment causes the air in the one or more air flow paths to flow through the one or more air flow paths.

2. The radiation protection garment of claim 1, wherein movement of the radiation protection garment causes ambient air to flow into the one or more air flow paths through the one or more air vents.

3. The radiation protection garment of claim 1, wherein the air within the one or more air flow paths includes cool air that mixes with warm air within the one or more air flow paths as the air flows through the one or more air flow paths.

4. The radiation protection garment of claim 1, wherein the one or more air flow paths are located on at least one of a front side, a rear side, a left side, or a right side of the radiation protection garment.

5. The radiation protection garment of claim 4, wherein the one or more air vents are located on the at least one of the front side, the rear side, the left side, or the right side of the radiation protection garment.

6. The radiation protection garment of claim 1, wherein the one or more air vents are unaligned with each other when the radiation protection garment is in a closed state.

7. The radiation protection garment of claim 1, further comprising an expandable belt that expands and retracts such that the radiation protection garment fits users of various sizes.

8. The radiation protection garment of claim 7, wherein the expandable belt comprises one or more lead strips and an elastic material looped together to form the expandable belt.

9. The radiation protection garment of claim 1, further comprising a support system that distributes a weight of the radiation protection garment away from at least one of a neck or a lower back of a user while the user is wearing the radiation protection garment.

10. The radiation protection garment of claim 9, wherein the support system comprises a first support mechanism located in an area of a bilateral iliac crest of the user when the user is wearing the radiation protection garment, the first support mechanism at least partially supporting the weight of the radiation protection garment at the bilateral iliac crest of the user.

11. The radiation protection garment of claim 10, wherein the first support mechanism includes one or more circumferential support mechanisms that extend circumferentially about the radiation protection garment.

12. The radiation protection garment of claim 10, wherein the support system comprises a second support mechanism located on a rear side of the radiation protection garment to distribute the weight of the radiation protection garment away from a lumbosacral region of the user.

13. The radiation protection garment of claim 12, wherein the second support mechanism includes one or more vertical support mechanisms, one or more horizontal support mechanisms, and one or more oblique support mechanisms.

14. The radiation protection garment of claim 12, wherein the second support mechanism includes an indentation having a curvature that conforms the radiation protection garment to the lumbosacral region of the user.

15. The radiation protection garment of claim 12, wherein the support system includes a third support mechanism located on at least one of a left side or a right side of the radiation protection garment, the third support mechanism extending substantially along a midaxillary line of the user while the user is wearing the radiation protection garment such that the third support mechanism at least partially supports the weight of the radiation protection garment at the midaxillary line of the user.

16. The radiation protection garment of claim 15, wherein the third support mechanism includes one or more posterior vertical support mechanisms.

17. The radiation protection garment of claim 1, wherein the radiation protection garment includes at least one of a radiation protection apron or a radiation protection skirt.

18. The radiation protection garment of claim 17, wherein the radiation protection apron includes a first apron flap and a second apron flap, the first apron flap overlaps the second apron flap on a front side of the radiation protection apron when the radiation protection apron is in a closed state.

19. The radiation protection garment of claim 18, wherein the first apron flap includes one or more of the one or more lead-based panels and the second apron flap includes one or more of the lead-based panels.

20. The radiation protection garment of claim 17, wherein the radiation protection apron includes an outwardly curved collar portion that extends forward from a front side of the radiation protection apron.

21. The radiation protection garment of claim 17, wherein the one or more lead-based panels include one or more chest lead-based panels in a chest area of the radiation protection apron, and the one or more chest lead-based panels extend laterally outwardly to cover breasts of a user.

22. The radiation protection garment of claim 17, further comprising at least one of a radiation protection shin guard, a radiation protection arm guard, a radiation protection neck guard, or a radiation protection head guard.

23. The radiation protection garment of claim 22, wherein the radiation protection shin guard includes a shin portion that covers a shin of a user, a foot portion that covers a foot of the user, and a support mechanism disposed between the shin portion and the foot portion that supports the shin portion on the foot portion.

24. The radiation protection garment of claim 22, wherein the radiation protection shin guard includes one or more zippers for securing the radiation protection shin guard on a user.

25. The radiation protection garment of claim 22, wherein the radiation protection arm guard includes a forearm portion that covers a forearm of a user and a hand portion that extends from the forearm portion and covers a hand of the user.

26. The radiation protection garment of claim 1, further comprising a radiation protection undergarment.

27. The radiation protection garment of claim 26, wherein the radiation protection undergarment comprises at least one of a radiation protection brassiere or a radiation protection underwear.

28. The radiation protection garment of claim 27, wherein the radiation protection undergarment includes one or more of the one or more lead-based panels.

29. A radiation protection garment comprising:
one or more lead-based panels; and
a support system that distributes a weight of the radiation protection garment away from at least one of a neck or a lower back of a user while the user is wearing the radiation protection garment.

30. The radiation protection garment of claim 29, wherein the support system comprises a first support mechanism located in an area of a bilateral iliac crest of the user when the user is wearing the radiation protection garment, the first support mechanism at least partially supporting the weight of the radiation protection garment at the bilateral iliac crest of the user.

31. The radiation protection garment of claim 30, wherein the first support mechanism includes one or more circumferential support mechanisms that extend circumferentially about the radiation protection garment.

32. The radiation protection garment of claim 30, wherein the support system comprises a second support mechanism located on a rear side of the radiation protection garment to distributes the weight of the radiation protection garment away from a lumbosacral region of the user.

33. The radiation protection garment of claim 32, wherein the second support mechanism includes one or more vertical support mechanisms, one or more horizontal support mechanisms, and one or more oblique support mechanisms.

34. The radiation protection garment of claim 32, wherein the second support mechanism includes an indentation having a curvature that conforms the radiation protection garment to the lumbosacral region of the user.

35. The radiation protection garment of claim 32, wherein the support system includes a third support mechanism located on at least one of a left side or a right side of the radiation protection garment, the third support mechanism extending substantially along a midaxillary line of the user while the user is wearing the radiation protection garment such that the third support mechanism at least partially supports the weight of the radiation protection garment at the midaxillary line of the user.

36. The radiation protection garment of claim 35, wherein the third support mechanism includes one or more posterior vertical support mechanisms.

37. The radiation protection garment of claim 29, further comprising a cooling system comprising:
one or more air flow paths, the one or more air flow paths containing air; and
one or more air vents that provide fluid communication between atmosphere and the one or more air flow paths, wherein movement of the radiation protection garment causes the air in the one or more air flow paths to flow through the one or more air flow paths and exit through the one or more air vents.

38. The radiation protection garment of claim 37, wherein movement of the radiation protection garment causes ambient air to flow into the one or more air flow paths through the one or more air vents.

39. The radiation protection garment of claim 37, wherein the air within the one or more air flow paths includes cool air that mixes with warm air within the one or more air flow paths as the air flows through the one or more air flow paths.

40. The radiation protection garment of claim 37, wherein the one or more air flow paths are located on at least one of a front side, a rear side, a left side, or a right side of the radiation protection garment.

41. The radiation protection garment of claim 40, wherein the one or more air vents are located on the at least one of the front side, the rear side, the left side, or the right side of the radiation protection garment.

42. The radiation protection garment of claim 37, wherein the one or more air vents are unaligned with each other when the radiation protection garment is in a closed state.

43. The radiation protection garment of claim 29, further comprising an expandable belt that expands and retracts such that the radiation protection garment fits users of various sizes.

44. The radiation protection garment of claim 43, wherein the expandable belt comprises one or more lead strips and an elastic material looped together to form the expandable belt.

45. The radiation protection garment of claim 29, wherein the radiation protection garment includes at least one of a radiation protection apron or a radiation protection skirt.

46. The radiation protection garment of claim 45, wherein the radiation protection apron includes a first apron flap and a second apron flap, the first apron flap overlaps the second apron flap on a front side of the radiation protection apron when the radiation protection apron is in a closed state.

47. The radiation protection garment of claim 46, wherein the first apron flap includes one or more of the one or more lead-based panels and the second apron flap includes one or more of the lead-based panels.

48. The radiation protection garment of claim 45, wherein the radiation protection apron includes an outwardly curved collar portion that extends forward from a front side of the radiation protection apron.

49. The radiation protection garment of claim 45, wherein the one or more lead-based panels include one or more chest lead-based panels in a chest area of the radiation protection apron, and the one or more chest lead-based panels extend laterally outwardly to cover breasts of a user.

50. The radiation protection garment of claim 45, further comprising at least one of a radiation protection shin guard, a radiation protection arm guard, a radiation protection neck guard, or a radiation protection head guard.

51. The radiation protection garment of claim 50, wherein the radiation protection shin guard includes a shin portion that covers a shin of a user, a foot portion that covers a foot of the user, and a support mechanism disposed between the shin portion and the foot portion that supports the shin portion on the foot portion.

52. The radiation protection garment of claim 51, wherein the radiation protection shin guard includes one or more zippers for securing the radiation protection shin guard on the user.

53. The radiation protection garment of claim 50, wherein the radiation protection arm guard includes a forearm portion that covers a forearm of a user and a hand portion that extends from the forearm portion and covers a hand of the user.

54. The radiation protection garment of claim 45, further comprising a radiation protection undergarment.

55. The radiation protection garment of claim 54, wherein the radiation protection undergarment comprises at least one of a radiation protection brassiere or a radiation protection underwear.

56. The radiation protection garment of claim 55, wherein the radiation protection underwear includes one or more of the one or more lead-based panels.
